(19) United States
(12) Patent Application Publication
(10) Pub. No.: US 2018/0205078 A1
(43) Pub. Date: Jul. 19, 2018

(54) TIN-CONTAINING COMPOUNDS

(71) Applicants: Sharp Kabushiki Kaisha, Osaka (JP); Faradion Limited, South Yorkshire (GB)

(72) Inventors: Emma KENDRICK, Oxford (GB); Robert GRUAR, Swindon (GB)

(21) Appl. No.: 15/746,419

(22) PCT Filed: Jul. 22, 2016
(86) PCT No.: PCT/JP2016/003434

§ 371 Date: Jan. 21, 2018

(30) Foreign Application Priority Data
Jul. 24, 2015 (GB) 1513117.0

(51) Int. Cl. H01M 4/505; C01G 53/00; H01M 4/525; H01M 10/054

(52) U.S. Cl. CPC H01M 4/505; C01G 53/50; C01G 53/42; C01P 2002/72; H01M 10/054; C01P 2006/40; C01P 2002/20; H01M 4/525

(57) ABSTRACT

A composition comprises the general formula Xᵤ Niᵥ Z_{b} Mnₓ Ti_{y} Sn_{w}, O₂, wherein: X consists of sodium or a mixture of group 1 metals having sodium as the major constituent; Z is one or more alkali metals selected from the group consisting of lithium and sodium; the X constituent and the Z constituent are present at crystallographically distinct sites when the compound is in a solid phase; 0<u 0<b<0.27; 0.1<v<½; 0<w≤ 4/12; 3/12≤x; and w+x+y=1−(b+v). It has been found that such materials may be charged to a capacity that is greater than the theoretical charging capacity of the material, as determined from the content of redox active elements in the material.

### TECHNICAL FIELD

The present invention relates to compounds containing tin and transition metals, their method of preparation, to novel electrodes which utilise an active material that comprises said tin and other transition metal-containing compounds, and to the use of these electrodes, for example in rechargeable batteries and other energy storage devices.

### BACKGROUND ART

Sodium-ion batteries are similar in many ways to lithium-ion batteries which have found wide spread application in energy storage devices and systems; they are reusable secondary batteries that comprise an anode (negative electrode), a cathode (positive electrode) and an electrolyte material. Lithium and Sodium ion batteries are both capable of storing energy, and they both charge and discharge via a similar reaction mechanism. When a sodium-ion (or lithium-ion battery) is charging, Na⁺ (or Li⁺) ions de-intercalate from the cathode and insert into the anode. Consequently, charge balancing electrons pass from the cathode through the external circuit and into the anode of the battery. During discharge the same process occurs but in the opposite direction.

Lithium-ion battery technology has been the subject of intensive research and provides the preferred portable battery technology for most electronic devices in use today; however lithium is not an abundant metal and is becoming more costly to source. In contrast sodium-ion battery technology is still in its relative infancy but is seen as advantageous; as sodium is much more abundant than lithium which some researchers predict will provide a cheaper and more sustainable technology by which to store energy into the future, particularly for large scale applications such as storing energy on the electrical grid or domestic energy storage. Nevertheless significant developments are required in terms of materials, operating voltage, specific capacity, material stability and energy efficiency before sodium-ion batteries become competitive with existing energy storage technologies.

Work is now being undertaken to find even more efficient electrochemically active materials, which have large charge capacity, are capable of good cycling performance, highly stable, are of low toxicity and high purity. This long list of requirements is difficult to fulfil but it is understood from the literature that the active materials which are most likely to succeed are those with small particle size and narrow size distribution, with an optimum degree of crystallinity, a high specific surface area, and with uniform morphology.

From the academic literature there are a number of know material compositions which can be used as electrochemically active materials for sodium ion batteries that belong to the class of materials known as the layered oxides. NaNi_{0.5}Mn_{0.5}O₂ is an example of a known Na-ion material in which the nickel is present as Ni²⁺ while the manganese is present as Mn⁴⁺. The material is ordered with the Na and Ni atoms residing in discrete sites within the structure. The nickel ions (Ni²⁺) are a redox element which contributes to the reversible specific capacity and the manganese ions (Mn⁴⁺) play the role of a structure stabiliser. Similarly, NaNi_{0.5}Ti_{0.5}O₂ is analogous to NaNi_{0.5} Mn_{0.5}O₂ in that the Ni²⁺ ions provide the active redox centre and the Ti⁴⁺ ions are present for structure stabilisation. There are a number of publications describing the preparation of NaNi_{0.5}Mn_{0.5}O₂ (and to a lesser extent NaNi_{0.5}Ti_{0.5}O₂) as the precursor for making LiNi_{0.5}Mn_{0.5}O₂ and LiNi_{0.5}Ti_{0.5}O₂ by Na→Li ion exchange for Li-ion applications. However, recent electrochemical studies reported by Komaba et al Adv. Funct. Mater. 2011, 21, 3859 describe the sodium intercalation performance of hardcarbon and layered NaNi_{0.5}Mn_{0.5}O₂ electrodes in propylene carbonate electrolyte solutions. The results obtained show that NaNi_{0.5}Mn_{0.5}O₂ exhibits some reversible charging and discharging ability approximately 140 mAh/g in an optimum potential window of 3.8-2.2 V Vs Na/Nat, however the capacity of the material fades by 25% or more, after only 40 cycles which makes the use of this material extremely disadvantageous for rechargeable energy storage applications. Further to this common knowledge there are a number of patent applications which detail improvements of electro active material performance. For example PCT/GB2013/051822 and PCT/GB2013/050736, describe that electrochemical activity is substantially improved in in terms of specific capacity and cathode material stability, for active materials with metal constituents of certain defined oxidation states and further particularly for active materials with an O3 layered oxide crystal structure. However, from the current state of the art it is clear that significant improvements are required in terms of electroactive material characteristics including; specific capacity, operating voltage and stability before Na-ion technology becomes competitive with existing energy storage technologies. Specifically, this application addresses the requirement for improvements in cathode materials for sodium ion batteries by disclosing materials which show improved stability, intercalation voltage and specific capacity.

As detailed below, this application discloses a series of material compositions suitable for application as cathode materials in an energy storage application. The Applicant has designed a novel series of compounds which are straightforward to manufacture, easy to handle and store, show high specific capacities and high stability. Further the invention provides cost effective electrode materials, particularly cathode materials, for use in a sodium ion battery or a sodium and lithium-ion battery.

The applicant has also shown that the as made Sodium layered oxides of the rationalised formula ABO₂ which crystallises in an O3 layered form are a preferred embodiment of the invention. It is known from the academic literature that layered oxides of the form ABO₂ can exist as several structural polymorphs, where layers of edge sharing octahedrally coordinated B cations (BO₆) are stacked perpendicular to layers of Prismatic or octahedrally coordinated “A” cations. A is generally an alkali metal atom and B is generally a transition metal atom. These compounds can be classified into two major groups, P2 type and O3 type, according to Delmas' notation (Delmas, et al. Physica B+C, 1980). The O or P designation refers to the local structure around Nat as either an octahedral or prismatic oxygen co-ordination, while the numerical designations refer to the repeat period of the transition metal stacking perpendicular to Na layers in a unit cell of the material. Further, the coordination of the A cation can also be describe as a ‘Partial co-ordination’ this has the notation of P′ in a partial prismatic coordination and O′ in a partial octahedral coordination.

Therefore, a first aspect of the present invention provides a compound having the general formula:

XᵤNiᵥZ_{b}MnₓTi_{y}Sn_{w}O₂

wherein X consists of sodium or a mixture of group 1 metals having sodium as the major constituent;

wherein Z is one or more alkali metals selected from the group consisting of lithium and sodium;

wherein the X constituent and the Z constituent are present at crystallographically distinct sites when the compound is in a solid phase; and

wherein:

0<u

0<b<0.27;

0.1<v<½;

0<w≤ 4/12;

3/12≤x; and

w+x+y=1−(b+v);

but not including Na Ni_{1/4} Na_{1/6} Mn_{4/12} Sn_{3/12} O₂ and Na Ni_{1/4} Na_{1/6} Mn_{13/24} Sn_{1/24} O₂.

The compound may have a layered oxide structure of the formula ABO₂ in the solid phase; and the X constituent may be predominantly on the A site and the Ni, Z, Mn, Ti and Sn constituents may be predominantly on the B site.

The compound may have an O3 layered oxide structure.

The values of u, v, b, x, y and w may be such as to maintain charge neutrality.

Optionally 0<w≤ 3/12 or 0<w≤ 2/12.

Optionally 1/24≤w.

Optionally y≤ 4/12.

Optionally 0<y, or 1/24<y.

Optionally w+x+y<0.64. Optionally w+x+y= 7/12.

Optionally b=⅙.

Optionally v=¼.

Optionally the compound can be charged beyond the theoretical capacity determined from the content of redox active elements. The theoretical capacity may be determined using equation (1) set out below.

The compound may have the formula:

Na Ni_{1/4} Na_{1/6} Mn_{4/12} Ti_{2/12} Sn_{1/12} O₂

Na Ni_{1/4} Na_{1/6} Mn_{3/12} Ti_{2/12} Sn_{2/12} O₂

Na Ni_{1/4} Na_{1/6} Mn_{6/12} Sn_{1/12} O₂

Na Ni_{1/4} Na_{1/6} Mn_{4/12} Sn_{3/12} O₂

Na Ni_{1/4} Na_{1/6} Ti_{1/12} Mn_{5/12} Sn_{1/12} O₂

Na Ni_{1/4} Na_{1/6}Ti_{1/12} Mn_{11/24} Sn_{1/24}O₂

Na Ni_{1/4} Na_{1/6} Ti_{1/24} Mn_{6/12} Sn_{1/24}O₂

Na Ni_{1/4} Na_{1/6} Ti_{1/24} Mn_{11/24} Sn_{1/12} O₂

Na Ni_{1/4} Na_{1/6} Ti_{4/24} Mn_{8/24} Sn_{1/12} O₂

Na Ni_{1/4} Na_{1/6} Ti_{3/12} Mn_{7/24} Sn_{1/24}O₂

Na Ni_{1/4} Na_{1/12} Li_{1/12} Ti_{2/12} Mn_{4/12} Sn_{1/12} O₂

Na Ni_{1/4} Na_{1/12} Li_{1/12} Ti_{1/24} Mn_{6/12} Sn_{1/24}O₂

Na Ni_{1/4} Na_{1/12} Li_{1/12} Ti_{4/24}Mn_{8/24} Sn_{2/24}O₂

Na Ni_{1/4} Na_{1/12} Li_{1/12} Mn_{13/24} Sn_{1/24}O₂

Preferably the sum of the average oxidation state of (A+B+M¹+M²+M³) is equal to the oxygen charge; i.e. it achieves charge neutrality with the oxygen content.

Preferably, M1 comprises Ni with an average oxidation state of 2+ to 4+.

Further the oxidation states may or may not be integers i.e. they may be whole numbers or fractions or a combination of whole numbers and fractions.

Preferably, when solid, the material forms an O3 layered oxide structure of the form ABO₂ in which the A atoms are octahedrally co-ordinated with oxygen and the B atoms are also octahedrally co-ordinated to oxygen.

Preferred compounds of the present invention include, for example:

Na Ni_{1/4} Na_{1/4} Li_{1/12} Ti_{2/12} Mn_{4/12} Sn_{1/12} O₂

Na Ni_{1/4} Na_{1/4} Li_{1/12} Ti_{1/24} Mn_{6/12} Sn_{1/24} O₂

Na Ni_{1/4} Na_{1/4} Li_{1/12} Ti_{4/24}Mn_{8/24} Sn_{2/24} O₂

Na Ni_{1/4} Na_{1/12} Li_{1/12} Mn_{13/24} Sn_{1/24} O₂

In these compounds, the “Na_{1/12} Li_{1/12}” corresponds to the constituent Z. That is, the last formula may alternatively be written as: Na Ni_{1/4} (Na_{1/2} Li_{1/2})_{1/6} Mn_{13/24} Sn_{1/24} O₂ and the previous three formulae may also be written in corresponding ways.

Especially preferred compounds of the present invention include:

Na Ni_{1/4} Na_{1/6} Mn_{1/12} Ti_{5/12} Sn_{1/12} O₂

Na Ni_{1/4} Na_{1/6} Mn_{2/12} Ti_{4/12} Sn_{1/12} O₂

Na Ni_{1/4} Na_{1/6} Mn_{4/12} Ti_{2/12} Sn_{1/12} O₂

Na Ni₁ₘ. Na_{1/6} Mn_{1/12} Ti_{4/12} Sn_{2/12} O₂

Na Ni_{1/4} Na_{1/6} Mn_{2/12} Ti_{3/12} Sn_{2/12} O₂

Na Ni_{1/4} Na_{1/6} Mn_{3/12} Ti_{2/12} Sn_{2/12} O₂

Na Ni_{1/4} Na_{1/6} Mn_{1/12} Ti_{3/12} Sn_{3/12} O₂

Na Ni_{1/4} Na_{1/6} Mn_{2/12} Ti_{2/12} Sn_{3/12} O₂

Na Ni_{1/4} Na_{1/6} Ti_{6/12} Sn_{1/12} O₂

Na Ni_{1/4} Na_{1/6} Ti_{4/12} Sn_{3/12} O₂

Na Ni_{1/4} Na_{1/6} Mn_{6/12} Sn_{1/12} O₂

Na Ni_{1/4} Na_{1/6} Mn_{4/12} Sn_{3/12} O₂

Na Ni_{1/4} Na_{1/6} Ti_{1/12} Mn_{5/12} Sn_{1/12} O₂

Na Ni_{1/4} Na_{1/6}Ti_{1/12} Mn_{11/24} Sn_{1/24} O₂

Na Ni_{1/4} Na_{1/6} Ti_{1/24} Mn_{6/12} Sn_{1/24} O₂

Na Ni_{1/4} Na_{1/6} Mn_{13/24} Sn_{1/24} O₂

Na Ni_{1/4} Na_{1/6} Ti_{1/24} Mn_{13/24} Sn_{1/12} O₂

Na Ni_{1/4} Na_{1/6} Ti_{4/24} Mn_{8/24} Sn_{1/12} O₂

Na Ni_{1/4} Na_{1/6} Ti_{3/12} Mn_{7/24} Sn_{1/24} O₂

A second aspect of the invention provides an electrode comprising a compound of the first aspect.

A third aspect of the invention provides an electrochemical cell comprising an electrode of the second aspect.

A fourth aspect of the invention provides an energy storage device comprising a compound of the first aspect.

The energy storage device may be suitable for use as one or more of the following: a sodium ion cell; a sodium and lithium ion cell; a sodium metal cell; a sodium and lithium metal cell; a non-aqueous electrolyte sodium ion cell; a non-aqueous electrolyte sodium and lithium ion cell.

A fifth aspect of the invention provides a rechargeable battery comprising a compound of the first aspect.

A sixth aspect of the invention provides an electrochemical device comprising an compound of the first aspect.

A seventh aspect of the invention provides an electrochromic device comprising an active compound of the first aspect.

An eighth aspect of the invention provides a method of preparing a compound of the first aspect, the method comprising the steps of:

a) mixing precursor materials together,

b) heating the mixed precursor materials in a furnace at a temperature of between 400° C. and 1000° C., for between 2 and 24 hours; and

c) allowing the reaction product to cool.

A ninth aspect of the invention provides a method comprising charging a material having the composition Xᵤ Niₚ Z_{b} Mn Ti_{y} Sn_{w} O₂ to a capacity greater than a theoretical charging capacity determined from the content of redox active elements in the material;

wherein X consists of sodium or a mixture of group 1 metals having sodium as the major constituent;

wherein Z is one or more alkali metals selected from the group consisting of lithium and sodium;

wherein; the X constituent and the Z constituent are present at crystallographically distinct sites when the compound is in a solid phase; and

wherein:

0<u;

0<b;

0.1<v<½;

0<w≤ 4/12;

at least one of x and y is non-zero; and

w+x+y=1−(b+v).

A tenth aspect of the invention provides a use of a material having the composition Xᵤ Niₚ Z_{b} Mnₓ Ti_{y} Sn_{w} O₂

wherein X consists of sodium or a mixture of group 1 metals having sodium as the major constituent;

wherein Z is one or more alkali metals selected from the group consisting of lithium and sodium;

wherein; the X constituent and the Z constituent are present at crystallographically distinct sites when the compound is in a solid phase; and

wherein:

0<u;

0<b;

0.1<v<½;

0<w≤ 4/12;

at least one of x and y is non-zero; and

w+x+y=1−(b+v);

the use comprising charging the material to a capacity greater than a theoretical charging capacity determined from the content of redox active elements in the material.

In a method of the ninth aspect or a use of the tenth aspect the theoretical capacity may be determined according to:

$$Specific Capacity ( {mAhg}^{- 1} ) = \frac{( ( Y \times {N}_{a} \times {Q}_{e} ) / {M}_{w} ) )}{3.6}$$

where:

Y is the number of electrons transferred per formula unit based on the content of redox active transition metals;

Nₐ is Avogadro's number;

Qₑ is Faraday's constant;

M_{w} is the molecular weight of the compound.

In the ninth or tenth aspect, the material may be charged to a specific capacity (expressed as charge stored per unit mass of material) that is at least 5% greater than the theoretical charging capacity, where the percentage increase is defined as 100×(O−T)/T where O is the observed specific charging capacity and T is the theoretical specific charging capacity.

Alternatively, the material may be charged to a specific capacity that is at least 10% greater than the theoretical charging capacity, or that is at least 15% greater than the theoretical charging capacity, or that is at least 20% greater than the theoretical charging capacity, or that is at least 30% greater than the theoretical charging capacity, or that is at least 40% greater than the theoretical charging capacity, or that is at least 50% greater than the theoretical charging capacity.

An eleventh aspect of the invention provides a compound having the general formula:

XᵤNiₚZ_{b}MnₓTi_{y}Sn_{w}O₂

wherein X consists of sodium or a mixture of group 1 metals having sodium as the major constituent;

wherein Z is one or more alkali metals selected from the group consisting of lithium and sodium;

wherein the X constituent and the Z constituent are present at crystallographically distinct sites when the compound is in a solid phase; and

wherein:

0<u

0<b<0.27;

0.1<v<½;

0<w≤ 4/12;

at least one of x and y is non-zero; and

w+x+y=1−(b+v).

A twelfth aspect of the invention provides compound having the general formula:

XᵤNiₚZ_{b}MnₓTi_{y}Sn_{w}O₂

wherein X consists of sodium or a mixture of group 1 metals having sodium as the major constituent;

wherein Z is one or more alkali metals selected from the group consisting of lithium and sodium;

wherein the X constituent and the Z constituent are present at crystallographically distinct sites when the compound is in a solid phase; and

wherein:

0<u

0<b<0.27;

0.1<v<½;

0<w;

0<y< 4/12; and

w+x+y=1−(b+v).

In the ninth, tenth, eleventh or twelfth aspect, the composition may have any optional feature that is specified for the first aspect and that is not already present in the ninth, tenth, eleventh or twelfth aspect respectively.

In the ninth, tenth or eleventh aspect, the composition may exclude Na Ni_{1/4} Na_{1/6} Mn_{4/12} Sn_{3/12} O₂, Na Ni_{1/4} Na_{1/6} Mn_{13/24} Sn_{1/24} O₂, Na Ni_{1/4} Na_{1/6} Mn_{1/12} Ti_{5/12} Sn_{1/12} O₂ and Na Ni_{1/4} Na_{1/6} Mn_{2/12} Ti_{4/12} Sn_{3/12} O₂.

The Applicant has found that, in the voltage ranges they have investigated, tin is itself mostly electrochemically inactive. Nevertheless, the Applicants have found that the presence of tin has no adverse effects of the specific energy density of the active compounds of the present invention, and moreover the addition of tin is found to have a stabilising effect on the structure of these active materials when used in the electrodes of the present invention. The presence of tin is found to be highly advantageous because it promotes higher than expected specific capacities than have been observed previously for other layered oxide materials. Such a result is extremely surprising, especially in respect of the sodium/tin-containing compounds of the present invention; in the case of such sodium/tin-containing compounds one would expect that the high atomic weight of sodium and tin would reduce the specific capacity but as demonstrated below this is not what is observed in practice. The presence of tin is further advantageous because it improves the electrochemical stability on cycling and produces active materials which are capable of being charged and recharged with only a moderate reduction in cycling capacity. Moreover, all of these advantages are obtained when only fractional amounts of tin are present in the active compounds.

Preferred electrodes of the present invention comprise compounds selected from one or more of the following:

Na Ni_{1/4} Na_{1/6} Mn_{1/12} Ti_{5/12} Sn_{1/12} O₂

Na Ni_{1/4} Na_{1/6} Mn_{2/12} Ti_{4/12} Sn_{1/12} O₂

Na Ni_{1/4} Na_{1/6} Mn_{4/12} Ti_{2/12} Sn_{1/12} O₂

Na Ni₁ₘ. Na_{1/6} Mn_{1/12} Ti_{4/12} Sn_{2/12} O₂

Na Ni_{1/4} Na_{1/6} Mn_{2/12} Ti_{3/12} Sn_{2/12} O₂

Na Ni_{1/4} Na_{1/6} Mn_{3/12} Ti_{2/12} Sn_{2/12} O₂

Na Ni_{1/4} Na_{1/6} Mn_{1/12} Ti_{3/12} Sn_{3/12} O₂

Na Ni_{1/4} Na_{1/6} Mn_{2/12} Ti_{2/12} Sn_{3/12} O₂

Na Ni_{1/4} Na_{1/6} Ti_{6/12} Sn_{1/12} O₂

Na Ni_{1/4} Na_{1/6} Ti_{4/12} Sn_{3/12} O₂

Na Ni_{1/4} Na_{1/6} Mn_{6/12} Sn_{1/12} O₂

Na Ni_{1/4} Na_{1/6} Mn_{4/12} Sn_{3/12} O₂

Na Ni_{1/4} Na_{1/6} Ti_{1/12} Mn_{5/12} Sn_{1/12} O₂

Na Ni_{1/4} Na_{1/6} Ti_{1/12} Mn_{11/24} Sn_{1/24} O₂

Na Ni_{1/4} Na_{1/6} Ti_{1/24} Mn_{6/12} Sn_{1/24} O₂

Na Ni_{1/4} Na_{1/6} Mn_{13/24} Sn_{1/24} O₂

Na Ni_{1/4} Na_{1/6} Ti_{1/24} Mn_{11/24} Sn_{1/12} O₂

Na Ni_{1/4} Na_{1/6} Ti_{4/24} Mn_{8/24} Sn_{1/12} O₂

Na Ni_{1/4} Na_{1/6} Ti_{3/12} Mn_{7/24} Sn_{1/24} O₂

Further, extremely preferred electrodes of the present invention comprise compounds selected from one or more of the following:

Na Ni_{1/4} Na_{1/6} Mn_{2/12} Ti_{4/12} Sn_{1/12} O₂

Na Ni_{1/4} Na_{1/6} Mn_{4/12} Ti_{2/12} Sn_{1/12} O₂

Na Ni₁ₘ. Na_{1/6} Mn_{1/12} Ti_{4/12} Sn_{2/12} O₂

Na Ni_{1/4} Na_{1/6} Ti_{6/12} Sn_{1/12} O₂

Na Ni_{1/4} Na_{1/6} Mn_{6/12} Sn_{1/12} O₂

Na Ni_{1/4} Na_{1/6} Ti_{1/12} Mn_{5/12} Sn_{1/12} O₂

Na Ni_{1/4} Na_{1/6} Ti_{1/12} Mn_{11/24} Sn_{1/24} O₂

Na Ni_{1/4} Na_{1/6} Ti_{1/24} Mn_{6/12} Sn_{1/24} O₂

Na Ni_{1/4} Na_{1/6} Mn_{13/24} Sn_{1/24} O₂

Na Ni_{1/4} Na_{1/6} Ti_{4/24} Mn_{8/24} Sn_{1/12} O₂

Na Ni_{1/4} Na_{1/6} Ti_{3/12} Mn_{7/24} Sn_{1/24} O₂

Advantageously, the electrodes according to the invention are used in conjunction with a counter electrode and one or more electrolyte materials. The electrolyte materials may be any conventional or known materials and may comprise non-aqueous electrolyte(s) or mixtures thereof.

As well as in electrodes, an active material according to the present invention is suitable for use in many different applications, for example in energy storage devices such as rechargeable batteries and other electrochemical devices. An active material according to the present invention may be used as part of an electrode in these energy storage devices.

In another aspect, the present invention provides an energy storage device that utilises one or more active materials according to the present invention as described above, and particularly an energy storage device for use as one or more of the following: a non-aqueous sodium and/or lithium ion cell; a non-aqueous sodium and/or lithium metal cell.

In a further aspect, the present invention provides cathode materials for sodium ion batteries which are capable of being charged beyond their theoretical capacity as determined by conventional calculation (Equation 1). Materials of the present invention are capable of being charged beyond their theoretical capacity many times without significant deterioration in observed capacity.

$$Specific Capacity ( {mAhg}^{- 1} ) = \frac{( ( Y \times {N}_{a} \times {Q}_{e} ) / {M}_{w} ) )}{3.6} \qquad Equation 1$$

Where,

Y is the number of electrons transferred per formula unit based on the content of redox active transition metals

Nₐ is Avogadro's number

Qₑ is Faraday's constant

M_{w} is the molecular weight of the compound

The novel compounds of the present invention may be prepared using any known and/or convenient method. For example, the precursor materials may be heated in a furnace so as to facilitate a solid state reaction process.

A further aspect of the present invention provides a particularly advantageous method for the preparation of the compounds described above comprising the steps of:

a) mixing the starting materials together, preferably intimately mixing the starting materials together and further preferably pressing the mixed starting materials into a pellet;

b) heating the mixed starting materials for example in a furnace, at a preferred temperature of between 400° C. and 1500° C., further preferably at a temperature of between 500° C. and 900° C., for between 0.1 and 20 hours; and

c) allowing the reaction product to cool.

Preferably the reaction is conducted under an atmosphere comprising one or more selected from ambient air and any other gaseous medium. Examples of a suitable gaseous medium include one or more selected from an inert gas, nitrogen and oxygen. Where two or more gases are used, they may be combined to produce a mixture, or alternatively, the two or more gases may be used sequentially either singly or in any combination, and in any order. Preferably an ambient air atmosphere is used.

### BRIEF DESCRIPTION OF DRAWINGS

The present invention will now be described with reference to the following figures in which:

FIG. 1(A) shows the Powder X-ray diffraction pattern for Na Ni_{1/4} Na_{1/6} Mn_{4/12} Ti_{2/12} Sn_{1/12} O₂, prepared according to Example 1;

FIG. 1(B) shows the Charge-Discharge Voltage Profiles for the first five cycles (Na-ion half cell Voltage [V Vs Na/Na⁺] versus Cumulative Cathode Specific Capacity [mAh/g]) for the cathode material prepared according to Example 1;

FIG. 1(C) shows the constant current cycle life profile (i.e. the relationship between cathode specific capacity for discharge [mAh/g] and cycle number for a Na Ni_{1/4} Na_{1/6} Mn_{4/12} Ti_{2/12} Sn_{1/12} O₂ cathode in accordance with Example 1.

FIG. 2(A) shows the Powder X-ray diffraction pattern for Na Ni_{1/4} Na_{1/6} Mn_{6/12} Sn_{1/12} O₂, prepared according to Example 2;

FIG. 2(B) shows the Charge-Discharge Voltage Profiles for the first five cycles (Na-ion half cell Voltage [V Vs Na/Na⁺] versus Cumulative Cathode Specific Capacity [mAh/g]) for the cathode material prepared according to Example 2;

FIG. 2(C) shows the constant current cycle life profile (i.e. the relationship between cathode specific capacity for discharge [mAh/g] and cycle number for a Na Ni_{1/4} Na_{1/6} Mn_{6/12} Sn_{1/12} O₂ cathode in accordance with Example 2.

FIG. 3(A) shows the Powder X-ray diffraction pattern for Na Ni_{1/4} Na_{1/6} Ti_{1/12} Mn_{5/12} Sn_{1/12} O₂, prepared according to Example 3;

FIG. 3(B) shows the Charge-Discharge Voltage Profiles for the first five cycles (Na-ion half cell Voltage [V Vs Na/Na⁺] versus Cumulative Cathode Specific Capacity [mAh/g]) for the cathode material prepared according to Example 3;

FIG. 3(C) shows the constant current cycle life profile (i.e. the relationship between cathode specific capacity for discharge [mAh/g] and cycle number for a Na Ni_{1/4} Na_{1/6}Ti_{1/12} Mn_{5/12} Sn_{1/12} O₂ cathode in accordance with Example 3.

FIG. 4(A) shows the Powder X-ray diffraction pattern for Na Ni_{1/4} Na_{1/6} Ti_{1/12} Mn_{11/24} Sn_{1/24} O₂, prepared according to Example 4;

FIG. 4(B) shows the Charge-Discharge Voltage Profiles for the first five cycles (Na-ion half cell Voltage [V Vs Na/Na⁺] versus Cumulative Cathode Specific Capacity [mAh/g]) for the cathode material prepared according to Example 4;

FIG. 4(C) shows the constant current cycle life profile (i.e. the relationship between cathode specific capacity for discharge [mAh/g] and cycle number for a Na Ni_{1/4} Na_{1/6}Ti_{1/12} Mn_{11/24} Sn_{1/24} O₂ cathode in accordance with Example 4.

FIG. 5(A) shows the Powder X-ray diffraction pattern for Na Ni_{1/4} Na_{1/6} Ti_{1/24} Mn_{6/12} Sn_{1/24} O₂, prepared according to Example 5;

FIG. 5(B) shows the Charge-Discharge Voltage Profiles for the first five cycles (Na-ion half cell Voltage [V Vs Na/Na⁺] versus Cumulative Cathode Specific Capacity [mAh/g]) for the cathode material prepared according to Example 5;

FIG. 5(C) shows the constant current cycle life profile (i.e. the relationship between cathode specific capacity for discharge [mAh/g] and cycle number for a Na Ni_{1/4} Na_{1/6}Ti_{1/24} Mn_{6/12} Sn_{1/24} O₂ cathode in accordance with Example 5.

FIG. 6(A) shows the Powder X-ray diffraction pattern for Na Ni_{1/4} Na_{1/6} Mn_{13/24} Sn_{1/24} O₂, prepared according to Example 6;

FIG. 6(B) shows the Charge-Discharge Voltage Profiles for the first five cycles (Na-ion half cell Voltage [V Vs Na/Na⁺] versus Cumulative Cathode Specific Capacity [mAh/g]) for the cathode material prepared according to Example 6;

FIG. 6(C) shows the constant current cycle life profile (i.e. the relationship between cathode specific capacity for discharge [mAh/g] and cycle number for a Na Ni_{1/4} Na_{1/6} Mn_{13/24} Sn_{1/24} O₂ cathode in accordance with Example 6.

FIG. 7(A) shows the Powder X-ray diffraction pattern for Na Ni_{1/4} Na_{1/6} Ti_{4/24} Mn_{8/24} Sn_{1/12} O₂ prepared according to Example 7;

FIG. 7(B) shows the Charge-Discharge Voltage Profiles for the first five cycles (Na-ion half cell Voltage [V Vs Na/Na⁺] versus Cumulative Cathode Specific Capacity [mAh/g]) for the cathode material prepared according to Example 7;

FIG. 7(C) shows the constant current cycle life profile (i.e. the relationship between cathode specific capacity for discharge [mAh/g] and cycle number for a Na Ni_{1/4} Na_{1/6} Ti_{4/24} Mn_{8/24} Sn_{1/12} O₂ cathode in accordance with Example 7.

FIG. 8(A) shows the Powder X-ray diffraction pattern for Na Ni_{1/4} Na_{1/6} Ti_{3/12} Mn_{7/24} Sn_{1/24} O₂, prepared according to Example 8;

FIG. 8(B) shows the Charge-Discharge Voltage Profiles for the first five cycles (Na-ion half cell Voltage [V Vs Na/Na⁺] versus Cumulative Cathode Specific Capacity [mAh/g]) for the cathode material prepared according to Example 8;

FIG. 8(C) shows the constant current cycle life profile (i.e. the relationship between cathode specific capacity for discharge [mAh/g] and cycle number for a Na Ni_{1/4} Na_{1/6} Ti_{3/12} Mn_{7/24} Sn_{1/24} O₂ cathode in accordance with Example 8.

FIG. 9(A) shows the Powder X-ray diffraction pattern for Na Ni_{1/4} Na_{1/12} Li_{1/12} Mn_{13/24} Sn_{1/24} O₂, prepared according to Example 9;

FIG. 9(B) shows the Charge-Discharge Voltage Profiles for the first five cycles (Na-ion half cell Voltage [V Vs Na/Na⁺] versus Cumulative Cathode Specific Capacity [mAh/g]) for the cathode material prepared according to Example 9;

FIG. 9(C) shows the constant current cycle life profile (i.e. the relationship between cathode specific capacity for discharge [mAh/g] and cycle number for a Na Ni_{1/4} Na_{1/12} Li_{1/12} Mn_{13/24} Sn_{1/24} O₂, cathode in accordance with Example 9.

FIG. 10 shows the Powder X-ray diffraction pattern for Na Ni_{1/4} Na_{1/6} Mn_{2/12} Ti_{4/12} Sn_{1/12} O₂, prepared according to Example 10;

FIG. 11 shows the Powder X-ray diffraction pattern for Na Ni_{1/4} Na_{1/6} Mn_{1/12} Ti_{4/12} Sn_{2/12} O₂, prepared according to Example 11;

FIG. 12 shows the Powder X-ray diffraction pattern for Na Ni_{1/4} Na_{1/6} Mn_{2/12} Ti_{3/12} Sn_{2/12} O₂, prepared according to Example 12;

FIG. 13 shows the Powder X-ray diffraction pattern for Na Ni_{1/4} Na_{1/6} Mn_{2/12} Ti_{2/12} Sn_{3/12} O₂, prepared according to Example 13;

FIG. 14 shows the Powder X-ray diffraction pattern for Na Ni_{1/4} Na_{1/6}Ti_{6/12} Sn_{1/12} O₂, prepared according to Example 14;

FIG. 15 shows the Powder X-ray diffraction pattern for Na Ni_{1/4} Na_{1/6}Ti_{4/12} Sn_{3/12} O₂, prepared according to Example 15;

FIG. 16 shows the Powder X-ray diffraction pattern for Na Ni_{1/4} Na_{1/6}Ti_{1/24} Mn_{13/24} Sn_{1/12} O₂, prepared according to Example 16;

FIG. 17 shows the Powder X-ray diffraction pattern for Na Ni_{1/4} Na_{1/6} Mn_{4/12} Sn_{3/12} O₂, prepared according to Example 17;

FIG. 18 shows the Powder X-ray diffraction pattern for Na Ni_{1/4} Na_{1/12} Li_{1/12} Ti_{2/12} Mn_{4/12} Sn_{1/12} O₂, prepared according to Example 18;

FIG. 19 shows the Powder X-ray diffraction pattern for Na Ni_{1/4} Na_{1/12} Li_{1/12} Ti_{1/24} Mn_{6/12} Sn_{1/24} O₂, prepared according to Example 19;

FIG. 20 shows the Powder X-ray diffraction pattern for Na Ni_{1/4} Na_{1/12} Li_{1/12} Ti_{4/24} Mn_{8/24} Sn_{2/24} O₂, prepared according to Example 20;

FIG. 21 shows specific capacity of compounds according to the present invention;

FIG. 22 shows average discharge voltage of compounds according to the present invention;

FIG. 23 shows cathode specific energy density of compounds according to the present invention;

FIG. 24 shows estimated material cost of compounds according to the present invention.

### DESCRIPTION OF EMBODIMENTS

The materials according to the present invention are prepared using the following typical generic method:

[Typical Generic Synthesis Method]

The required amounts of the precursor materials are intimately mixed together and retained as a free flowing powder. The resulting mixture is then heated, for example in a tube furnace or a chamber furnace, under atmospheric conditions comprising one or more selected from ambient air, nitrogen, oxygen and an inert gas (e.g. argon). Where two or more gases are used, they may be combined to produce a mixture, or alternatively, the two or more gases may be used sequentially, either singly or in any combination, and in any order. Preferably an air atmosphere is used followed by an atmosphere of nitrogen. The gases may be static or flowing. The heating temperature may be a single or a range of temperatures, ideally from 400° C. to 1500° C. and heating is continued until reaction product forms; for some materials a single heating step may be used and for others (as indicated below in Table 1) more than one heating step may be used. For ease of handling, the reaction product is allowed to cool and then removed from the furnace and then ground into a powder prior to characterisation.

Using the above typical generic method, active materials were prepared according to, Examples 1 to 20, as summarised below in Table 1:

TABLE 1
Summary of reactions which can be used to produce target materials

| EXAM- | | STARTING | FURNACE |
|---|---|---|---|
| PLE | TARGET COMPOUND | MATERIALS | CONDITIONS |
| 1 | Na Ni_{1/4} Na_{1/6} Mn_{4/12} Ti_{2/12} | Na₂CO₃ | 900° C., 10 h, |
| | Sn_{1/12} O₂ | Mn CO₃ | Air |
| | | SnO₂ | |
| | | TiO₂ | |
| | | NiCO₃ | |
| 2 | Na Ni_{1/4} Na_{1/6} Mn_{6/12} Sn_{1/12} | Na₂CO₃ | 900° C., 10 h, |
| | O₂ | Mn CO₃ | Air |
| | | SnO₂ | |
| | | TiO₂ | |
| | | NiCO₃ | |
| 3 | Na Ni_{1/4} Na_{1/6} Ti_{1/12} Mn_{5/12} | Na₂CO₃ | 900° C., 10 h, |
| | Sn_{1/12} O₂ | Mn CO₃ | Air |
| | | SnO₂ | |
| | | TiO₂ | |
| | | NiCO₃ | |
| 4 | Na Ni_{1/4} Na_{1/6} Ti_{1/12} Mn_{11/24} | Na₂CO₃ | 900° C., 10 h, |
| | Sn_{1/24} O₂ | Mn CO₃ | Air |
| | | SnO₂ | |
| | | TiO₂ | |
| | | NiCO₃ | |
| 5 | Na Ni_{1/4} Na_{1/6} Ti_{1/24} Mn_{6/12} | Na₂CO₃ | 900° C., 10 h, |
| | Sn_{1/24} O₂ | Mn CO₃ | Air |
| | | SnO₂ | |
| | | TiO₂ | |
| | | NiCO₃ | |
| 6 | Na Ni_{1/4} Na_{1/6} Mn_{13/24} Sn_{1/24} | Na₂CO₃ | 900° C., 10 h, |
| | O₂ | Mn CO₃ | Air |
| | | SnO₂ | |
| | | TiO₂ | |
| | | NiCO₃ | |
| 7 | Na Ni_{1/4} Na_{1/6} Ti_{4/24} | Na₂CO₃ | 900° C., 10 h, |
| | Mn_{8/24}Sn_{1/12} O₂ | Mn CO₃ | Air |
| | | SnO₂ | |
| | | TiO₂ | |
| | | NiCO₃ | |
| 8 | Na Ni_{1/4} Na_{1/6} Ti_{3/12} Mn_{7/24} | Na₂CO₃ | 900° C., 10 h, |
| | Sn_{1/24} O₂ | Mn CO₃ | Air |
| | | SnO₂ | |
| | | TiO₂ | |
| | | NiCO₃ | |
| 9 | Na Ni_{1/4} Na_{1/12} Li_{1/12} Mn_{13/24} | Li₂CO₃ | (600° C., 8 h, |
| | Sn_{1/24} O₂ | Na₂CO₃ | Air) milled |
| | | Mn CO₃ | (900° C., 10 h, |
| | | SnO₂ | Air) |
| | | TiO₂ | |
| | | NiCO₃ | |
| 10 | Na Ni_{1/4} Na_{1/6} Mn_{2/12}Ti_{4/12} | Na₂CO₃ | 900° C., 10 h, |
| | Sn_{1/12} O₂ | Mn CO₃ | Air |
| | | SnO₂ | |
| | | TiO₂ | |
| | | NiCO₃ | |
| 11 | Na Ni_{1/4} Na_{1/6} Mn_{1/12}Ti_{4/12} | Na₂CO₃ | 900° C., 10 h, |
| | Sn_{2/12} O₂ | Mn CO₃ | Air |
| | | SnO₂ | |
| | | TiO₂ | |
| | | NiCO₃ | |
| 12 | Na Ni_{1/4} Na_{1/6} Mn_{2/12}Ti_{3/12} | Na₂CO₃ | 900° C., 10 h, |
| | Sn_{2/12} O₂ | Mn CO₃ | Air |
| | | SnO₂ | |
| | | TiO₂ | |
| | | NiCO₃ | |
| 13 | Na Ni_{1/4} Na_{1/6} Mn_{2/12}Ti_{2/12} | Na₂CO₃ | 900° C., 10 h, |
| | Sn_{3/12} O₂ | Mn CO₃ | Air |
| | | SnO₂ | |
| | | TiO₂ | |
| | | NiCO₃ | |
| 14 | Na Ni_{1/4} Na_{1/6} Ti_{6/12} Sn_{1/12} | Na₂CO₃ | 900° C., 10 h, |
| | O₂ | Mn CO₃ | Air |
| | | SnO₂ | |
| | | TiO₂ | |
| | | NiCO₃ | |
| 15 | Na Ni_{1/4} Na_{1/6} Ti_{4/12} Sn_{3/12} | Na₂CO₃ | 900° C., 10 h, |
| | O₂ | Mn CO₃ | Air |
| | | SnO₂ | |
| | | TiO₂ | |
| | | NiCO₃ | |
| 16 | Na Ni_{1/4} Na_{1/6} Ti_{1/24} Mn_{13/24} | Na₂CO₃ | 900° C., 10 h, |
| | Sn_{1/12} O₂ | Mn CO₃ | Air |
| | | SnO₂ | |
| | | TiO₂ | |
| | | NiCO₃ | |
| 17 | Na Ni_{1/4} Na_{1/6} Mn_{4/12} Sn_{3/12} | Na₂CO₃ | 900° C., 10 h, |
| | O₂ | Mn CO₃ | Air |
| | | SnO₂ | |
| | | TiO₂ | |
| | | NiCO₃ | |
| 18 | Na Ni_{1/4} Na_{1/12} Li_{1/12} Ti_{2/12} | Li₂CO₃ | (600° C., 8 h, |
| | Mn_{4/12} Sn_{1/12} O₂ | Na₂CO₃ | Air) milled |
| | | Mn CO₃ | (900° C., 10 h, |
| | | SnO₂ | Air) |
| | | TiO₂ | |
| | | NiCO₃ | |
| 19 | Na Ni_{1/4} Na_{1/12} Li_{1/12} Ti_{1/24} | Li₂CO₃ | (600° C., 8 h, |
| | Mn_{6/12} Sn_{1/24} O₂ | Na₂CO₃ | Air) milled |
| | | Mn CO₃ | (900° C., 10 h, |
| | | SnO₂ | Air) |
| | | TiO₂ | |
| | | NiCO₃ | |
| 20 | Na Ni_{1/4} Na_{1/12} Li_{1/12} Ti_{4/24} | Li₂CO3 | (600° C., 8 h, |
| | Mn_{8/24} Sn_{2/24} O₂ | Na₂CO₃ | Air) milled |
| | | Mn CO₃ | (900° C., 10 h, |
| | | SnO₂ | Air) |
| | | TiO₂ | |
| | | NiCO₃ | |

All of the product materials were analysed by X-ray diffraction techniques using a Bruker D2 phaser powder diffractometer (fitted with a Lynxeye (trademark) detector) to confirm that the desired target materials had been prepared, and also to establish the phase purity of the products and to determine the types of impurities present. From this information it is possible to determine the unit cell lattice parameters. It is also possible to determine the average position of different elements within the materials structure.

The operating conditions used to obtain the powder diffraction patterns illustrated in the Figures are as follows:

Range: 2θ=10°-70°

X-ray Wavelength=1.5418 Å (Angstroms) (Cu Kα)

Step size: 2θ=0.04
Speed: 0.1 seconds/step

[Typical Generic Procedure to Make a Sodium Metal Electrochemical Test Cell:]

The positive electrode is prepared by solvent-casting a slurry containing the active material as described in Table 1, conductive carbon, binder and solvent. The conductive carbon used is Super P C65 (Timcal). PVdF is used as the binder, and NMP (N-Methyl-2-pyrrolidone, Anhydrous, Sigma, UK) is employed as the solvent. The slurry is then cast onto an aluminium current collector using the Doctor-blade technique. The electrode is then dried under Vacuum at about 80° C. for between 2 and 24 h. The electrode film contains the following components, expressed in percent by weight: 75% active material, 18% Super P carbon, and 7% binder. Optionally, this ratio can be varied to optimise the electrode properties such as, adhesion, resistivity and porosity. The electrolyte comprises a 0.5 or 1.0 M solution of NaClO₄ in propylene carbonate (PC), mostly a 0.5 M solution of NaClO₄ in propylene carbonate. A glass fibre separator (e.g. Whatman, GF/A) wetted by the electrolyte is interposed between the positive and negative electrodes forming the electrochemical test cell. Typically, cells are symmetrically charged and discharged galvanostatically at a rate of 10 mA/g.

[Cell Testing:]

Electrochemical cells of materials prepared according to the procedures outlined in Table 1 were tested as follows using Constant Current Cycling Techniques and the results are presented in Table 2.

The cell was cycled at a given current density (ca. 10 mA/g) between pre-set voltage limits. A commercial battery cycler from Maccor Inc. (Tulsa, Okla., USA) was used. Cells were charged symmetrically between the upper and lower voltage limits at a constant current density as defined in Table 2 for each of the target material described in Table 1. On charge, sodium ions are extracted from the cathode and migrate to the anode. On discharge, the reverse process occurs and Sodium ions are re-inserted into the cathode material.

TABLE 2
Electrochemistry Results

| | Electrochemistry | | | | | |
|---|---|---|---|---|---|---|
| | | Maximum | | | | |
| | Redox | capacity | | Exp. | Potential | |
| | capacity | (mAh/g) | Observed | average | window | |
| | (mAh/g) per | Theoretical | Capacity | Voltage | (V Vs | |
| EXAMPLE | mol Na | (Ni basis) | (mAh/g) | (V) | Na/Na+) | Material Composition |
| 1 | 244 | 122 | 190 | 3.25 | 4.3-1.5 | Na Ni_{1/4} Na_{1/6} |
| | | | | | | Mn_{4/12}Ti_{2/12} Sn_{1/12} O₂ |
| 2 | 242 | 121 | 190 | 3.17 | 4.3-1.5 | Na Ni_{1/4} Na_{1/6} Mn_{6/12} |
| | | | | | | Sn_{1/12} O₂ |
| 3 | 243 | 122 | 186 | 3.26 | 4.3-1.5 | Na Ni_{1/4} Na_{1/6} Ti_{1/12} |
| | | | | | | Mn_{5/12} Sn_{1/12} O₂ |
| 4 | 249 | 125 | 190 | 3.26 | 4.3-1.5 | Na Ni_{1/4} Na_{1/6} Ti_{1/12} |
| | | | | | | Mn_{11/24} Sn_{1/24} O₂ |
| 5 | 248 | 124 | 200 | 3.22 | 4.3-1.5 | Na Ni_{1/4} Na_{1/6} Ti_{1/24} |
| | | | | | | Mn_{6/12} Sn_{1/24} O₂ |
| 6 | 248 | 124 | 200 | 3.22 | 4.3-1.5 | Na Ni_{1/4} Na_{1/6} Mn_{13/24} |
| | | | | | | Sn_{1/24} O₂ |
| 7 | 244 | 122 | 208 | 3.26 | 4.3-1.5 | Na Ni_{1/4} Na_{1/6}Ti_{4/24} |
| | | | | | | Mn_{8/24}Sn_{1/12} O₂ |
| 8 | 252 | 126 | 190 | 3.23 | 4.3-1.5 | Na N_{1/4} Na_{1/6} Ti_{3/12} |
| | | | | | | Mn_{7/24} Sn_{1/24} O₂ |
| 9 | 251 | 125 | 191 | 3.10 | 4.3-1.5 | Na Ni_{1/4} Na_{1/12} Li_{1/12} |
| | | | | | | Mn_{13/24} Sn_{1/24} O₂ |
| 10 | 247 | 124 | 158 | 3.20 | 4.3-1.5 | Na Ni_{1/4} Na_{1/6} |
| | | | | | | Mn_{2/12}Ti_{4/12}Sn_{1/12} O₂ |
| 11 | 235 | 118 | 150 | 3.23 | 4.3-1.5 | Na Ni_{1/4} Na_{1/6} |
| | | | | | | Mn_{1/12}Ti_{4/12}Sn_{2/12} O₂ |
| 12 | 234 | 117 | 148 | 3.16 | 4.3-1.5 | Na Ni_{1/4} Na_{1/6} |
| | | | | | | Mn_{2/12}Ti_{3/12} Sn_{2/12} O₂ |
| 13 | 223 | 111 | 152 | 3.00 | 4.3-1.5 | Na Ni_{1/4} Na_{1/6} |
| | | | | | | Mn_{2/12}Ti_{2/12} Sn_{3/12} O₂ |
| 14 | 250 | 125 | 142 | 3.21 | 4.3-1.5 | Na Ni_{1/4} Na_{1/6} Ti_{6/12} |
| | | | | | | Sn_{1/12} O₂ |
| 15 | 225 | 112 | 118 | 3.19 | 4.3-1.5 | Na Ni_{1/4} Na_{1/6} Ti_{4/12} |
| | | | | | | Sn_{3/12} O₂ |
| 16 | 242 | 121 | 175 | 3.19 | 4.3-1.5 | Na Ni_{1/4} Na_{1/6} Ti_{1/24} |
| | | | | | | Mn_{13/24} Sn_{1/12} O₂ |
| 17 | 221 | 110 | 151 | 3.15 | 4.3-1.5 | Na Ni_{1/4} Na_{1/6} Mn_{4/12} |
| | | | | | | Sn_{3/12} O₂ |
| 18 | 247 | 124 | 158 | 3.10 | 4.3-1.5 | Na Ni_{1/4} Na_{1/12} Li_{1/12} |
| | | | | | | Ti_{2/12} Mn_{4/12} Sn_{1/12} O₂ |
| 19 | 251 | 126 | 178 | 3.20 | 4.3-1.5 | Na Ni_{1/4} Na_{1/12} Li_{1/12} |
| | | | | | | Ti_{1/24} Mn_{6/12} Sn_{1/24} O₂ |
| 20 | 247 | 124 | 168 | 3.10 | 4.3-1.5 | Na Ni_{1/4} Na_{1/12} Li_{1/12} |
| | | | | | | Ti_{4/24}Mn_{8/24} Sn_{2/24} O₂ |

### Detailed Description of Results:

The present Applicant has found that not only are the oxidation states of the metal constituents in the compounds of the present invention a critical feature to the production of highly electrochemically active compounds but they have also confirmed that having metal constituents with these particular oxidation states will determine the overall crystalline structure of the compound. It is known that there are several possible layered structural forms which alkali metal/metal/oxides may adopt, including O3, P3 and P2 crystal structures as defined by the notation reported by Delmas (Delmas, et al. Physica B+C, 1980). The Applicant has shown that the oxidation states for the metal constituents cause a particular structure to be adopted and has determined that alkali metal/metal/oxide compounds with a metal in +4 oxidation state and with a sodium content >1 (where the sodium content includes sodium at both the A and B sites ie, also includes the Z constituent), will adopt an O3 crystalline structure. The applicant has also demonstrated that appropriate choice of transition metal and alkali metal constituents can control occupancy by certain elements on certain crystallographic sites within the material. Moreover, the Applicant has demonstrated that alkali metal/metal/oxides with the metal in oxidation state +4 and with an O3 crystalline structure exhibit a much higher electrochemical activity than similar compounds that do not contain a metal in +4 oxidation state such as tin. Although, tin is itself electrochemically inactive at the operation voltages disclosed in the invention (˜+4 oxidation state), it has been demonstrated by the applicant to have a stabilising effect on the structure of the active materials used in the electrodes of the present invention. Further, the presence of tin is particularly advantageous to improve the electrochemical stability upon cycling; resulting in the active materials which are capable of being charged and recharged numerous times.

Also, it will be seen that the compositions listed in Table 2 may be charged to a specific capacity (expressed in charge per unit mass of material) that is greater than the theoretical specific charging capacity as calculated from the content of redox active transition metals in the material according to equation 1 above. The theoretical specific charging capacity is listed in the second column of Table 2 above (as “Maximum capacity (mAh/g) Theoretical basis”) and the observed charging capacity is listed in column 3 of Table 2. It will be seen that the lowest percentage increase in specific charging capacity, defined as 100× (O−T)/T where O is the observed specific charging capacity of column 3 and T is the theoretical specific charging capacity of column 2, is approximately 5% (for Example 15). Apart from Example 15, all other examples in Table 2 provide an increase of approximately 15% or greater, with the greatest observed increase being approximately 70% for Example 7. (The first column in Table 2 shows the theoretical molar charging capacity—“Redox capacity (mAh/g) per mol Na”. In all the examples the Ni content is 0.25, so it is possible to remove 0.5 mol of Na when the Ni undergoes a Ni2+→Ni4+ redox reaction. The theoretical specific charging capacity listed in the second column of Table 2 is therefore half the theoretical molar capacity.)

These observations will now be explained with reference to Examples 1-20.

The Electrochemical Properties of Na Ni_{1/4} Na_{1/6} Mn_{4/12} Ti_{2/12} Sn_{1/12} O₂ Prepared in Example 1.

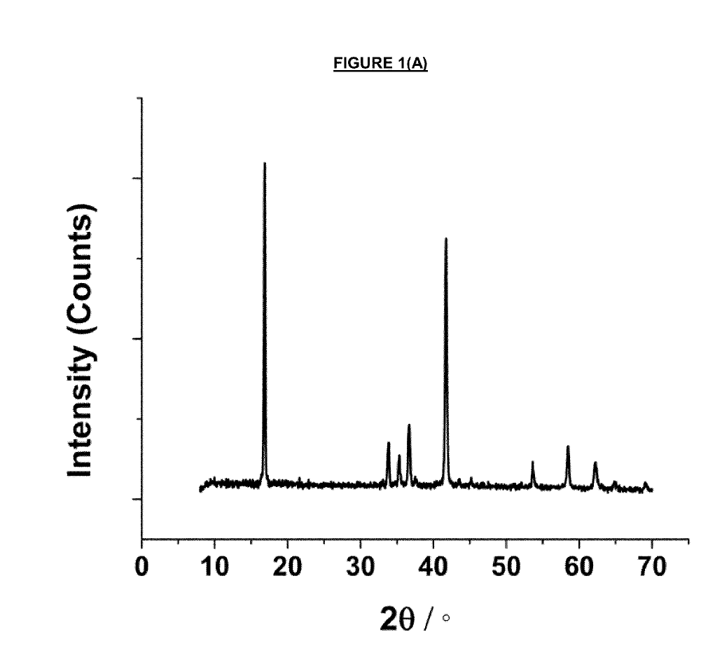

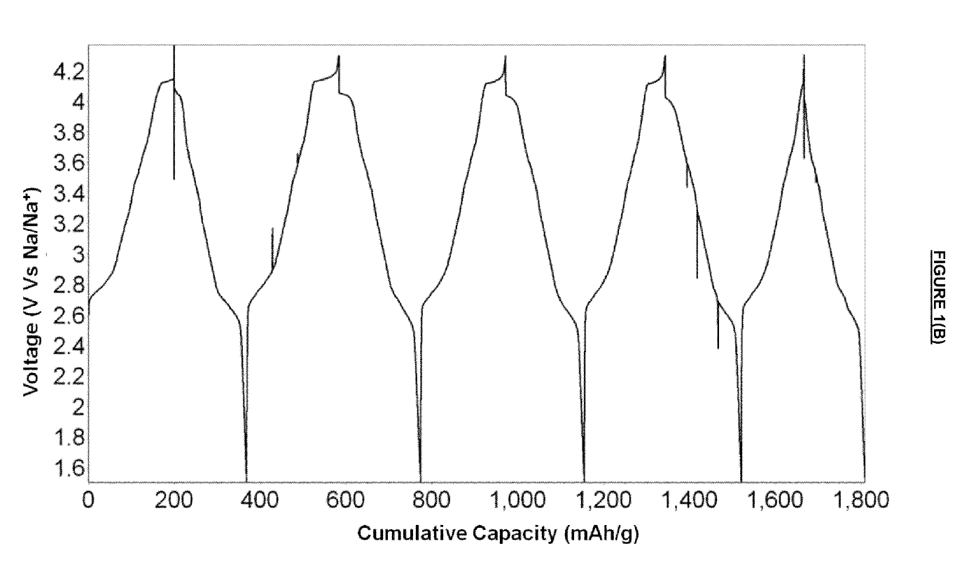

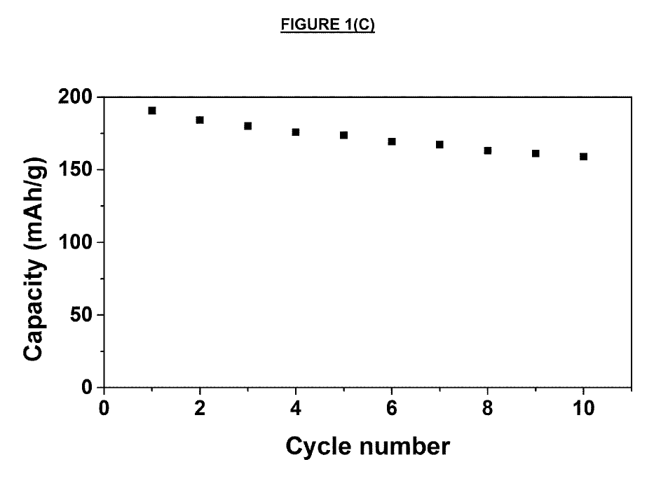

FIG. 1(A) shows the powder X-ray diffraction pattern of the target compound from Example 1 of Table 1, Na Ni_{1/4} Na_{1/6} Mn_{4/12} Ti_{2/12} Sn_{1/12} O₂ having an O3 layered oxide phase. The target compound of Example 1 was analysed using the X-ray diffraction technique described above. FIG. 1(A) shows the intensity (counts) versus the range of 10°-70° 2θ.

The data shown in FIGS. 1(B) and 1(C) are derived from the constant current cycling data for a Na Ni_{1/4} Na_{1/6} Mn_{4/12} Ti_{2/12} Sn_{1/12} O₂ cathode active material in a Na metal half cell where this cathode material was cycled against a thin film of Na metal. The electrolyte used was a 0.5 M solution of NaClO₄ in propylene carbonate (PC). The constant current data was collected at an approximate current of 10 mA/g between voltage limits of 1.50 and 4.30 V Vs Na/Na⁺ and the testing was undertaken at room temperature (i.e., 22° C.). During the cell charging process, sodium ions are extracted from the cathode active material, and plated/deposited onto the Na metal anode. During the subsequent discharge process, sodium ions are stripped from the sodium metal anode and re-intercalate into the cathode active material. FIG. 1(B) shows the cell voltage profile (Cell Voltage [V] versus Cumulative Cathode Specific Capacity (milliamp hours per gram [mAh/g])) for the first five charge/discharge cycles of Na Ni_{1/4} Na_{1/6} Mn_{4/12} Ti_{2/12} Sn_{1/12} O₂ cycled in a sodium metal cell. FIG. 1(C) shows the constant current cycle life profile (i.e. the relationship between cathode specific capacity for discharge [mAh/g] and cycle number for a Na Ni_{1/4} Na_{1/6} Mn_{4/12} Ti_{2/12} Sn_{1/12} O₂ cathode).

When the characteristics of the invented material Na Ni_{1/4} Na_{1/6} Mn_{4/12} Ti_{2/12} Sn_{1/12} O₂ are compared to recent electrochemical studies reported by Komaba et al Adv. Funct. Mater. 2011, 21, 3859 which describe the sodium insertion performance of hardcarbon and layered NaNi_{0.5}Mn_{0.5}O₂ electrodes in propylene carbonate electrolyte solutions. The results obtained for Na Ni_{1/4} Na_{1/6} Mn_{4/12} Ti_{2/12} Sn_{1/12} O₂ show that the invented material exhibits a significantly larger reversible capacity. An improvement in material stability is also observed when compared to NaNi_{0.5}Mn_{0.5}O₂ described in Komaba et al Adv. Funct. Mater. 2011, 21, 3859. Typically, NaNi_{0.5}Mn_{0.5}O₂ shows a reversible capacity of 140 mAh/g. In comparison, Na Ni_{1/4} Na_{1/6} Mn_{4/12} Ti_{2/12} Sn_{1/12} O₂ demonstrates a reversible capacity of 190 mAh/g. It can be seen that appropriate atomic substitution as disclosed in this invention yields materials which demonstrate significant increases in reversible capacity. It can also be seen from FIG. 1(B) that the invented material Na Ni_{1/4} Na_{1/6} Mn_{4/12} Ti_{2/12} Sn_{1/12} O₂ demonstrates higher reversible capacity and stability over a larger potential window than the prior art material NaNi_{0.5}Mn_{0.5}O₂. As can be seen in FIG. 1(B) the invented material Na Ni_{1/4} Na_{1/6} Mn_{4/12} Ti_{2/12} Sn_{1/12} O₂ demonstrates significant reversible capacity and stability in the potential window 1.5 to 4.3 V Vs Na/Na+. This stability range is significantly wider than that observed for the prior art material NaNi_{0.5}Mn_{0.5}O₂ that demonstrates optimum reversible capacity in the potential window 2.2 to 3.8 V Vs Na/Na⁺. This yields a higher average intercalation potential in the invented material over the prior art material which increases further the utility of these compounds for application in rechargeable batteries. In FIG. 1(C) it can also be seen that the invented material Na Ni_{1/4} Na_{1/6} Mn_{4/12} Ti_{2/12} Sn_{1/12} O₂ demonstrates reasonable capacity retention over the first ten electrochemical cycles.

The Electrochemical Properties of Na Ni_{1/4} Na_{1/6} Mn_{6/12} Sn_{1/12} O₂ Prepared in Example 2.

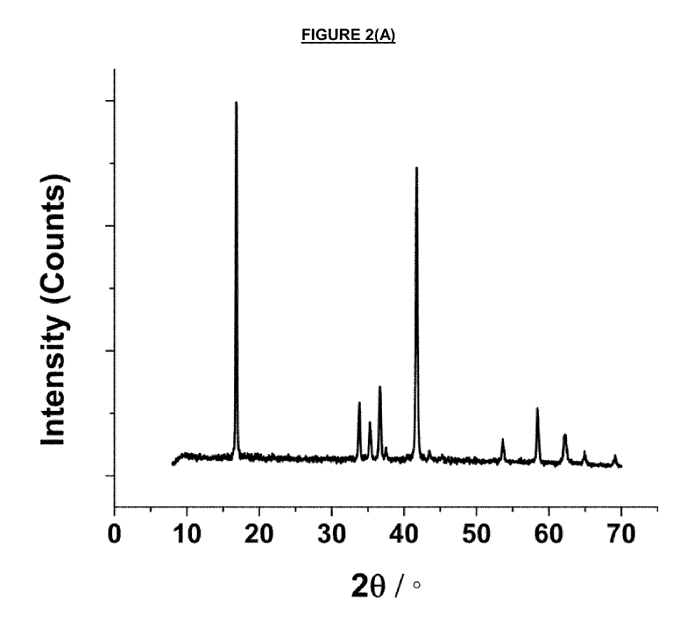

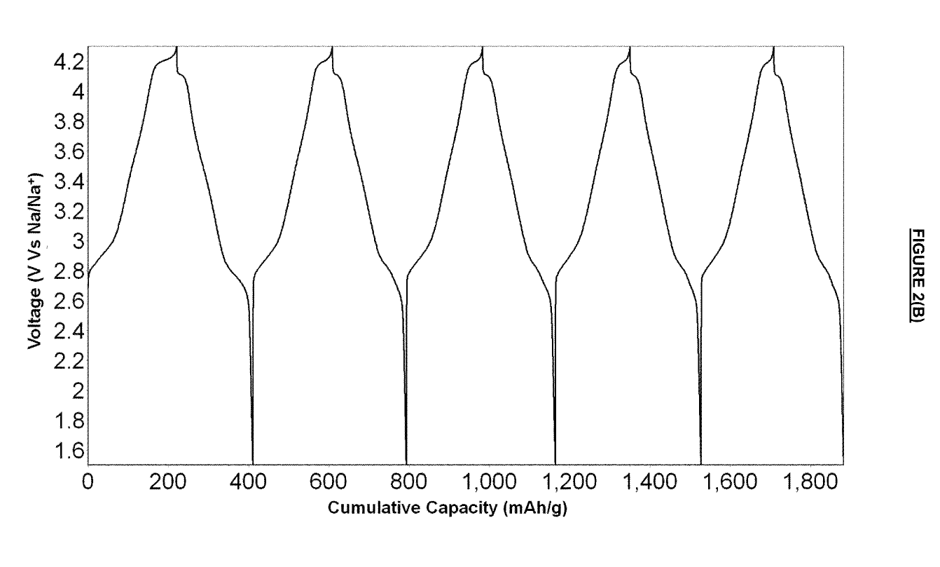

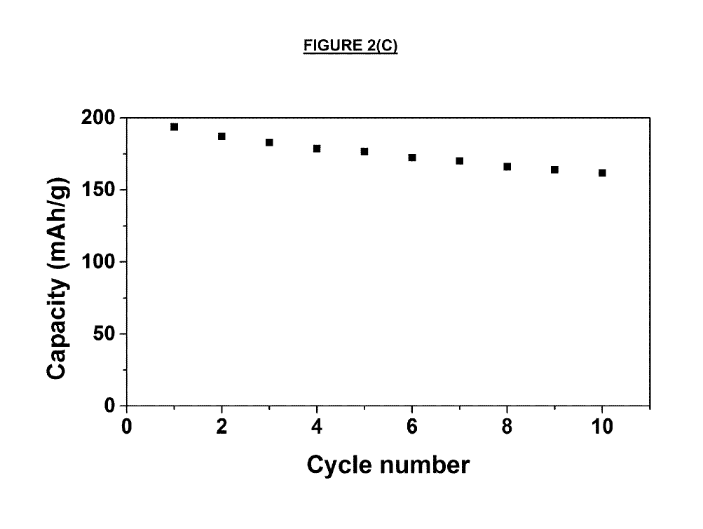

FIG. 2(A) shows the powder X-ray diffraction pattern of the target compound from Example 2 of Table 1, Na Ni_{1/4} Na_{1/6} Mn_{6/12} Sn_{1/12} O₂ having an O3 layered oxide phase. The target compound of Example 2 was analysed using the X-ray diffraction technique described above. FIG. 2(A) shows the intensity (counts) versus the range of 10°-70° 2θ for Na Ni_{1/4} Na_{1/6} Mn_{6/12} Sn_{1/12} O₂.

The data shown in FIGS. 2(B) and 2(C) are derived from constant current cycling data for a Na Ni_{1/4} Na_{1/6} Mn_{6/12} Sn_{1/12} O₂ cathode active material in a Na metal half cell where this cathode material was cycled against a thin film of Na metal. The electrolyte used was a 0.5 M solution of NaClO₄ in propylene carbonate (PC). The constant current data was collected at an approximate current of 10 mA/g between voltage limits of 1.50 and 4.30 V Vs Na/Na⁺ and the testing was undertaken at room temperature (i.e., 22° C.). The testing was carried out in an analogous manner to that reported for Example 1. FIG. 2(B) shows the cell voltage profile (Cell Voltage [V] versus Cumulative Cathode Specific Capacity (milliamp hours per gram [mAh/g])) for the first five charge/discharge cycles of Na Ni_{1/4} Na_{1/6} Mn_{6/12} Sn_{1/12} O₂ cycled in a sodium metal cell. FIG. 2(C) shows the constant current cycle life profile (i.e. the relationship between cathode specific capacity for discharge [mAh/g] and cycle number for a Na Ni_{1/4} Na_{1/6} Mn_{6/12} Sn_{1/12} O₂ cathode).

When the characteristics of the invented material Na Ni_{1/4} Na_{1/6} Mn_{6/12} Sn_{1/12} O₂ are compared to recent electrochemical studies reported by Komaba et al Adv. Funct. Mater. 2011, 21, 3859 which describe the sodium insertion performance of hardcarbon and layered NaNi_{0.5}Mn_{0.5}O₂ electrodes in propylene carbonate electrolyte solutions. The results obtained for Na Ni_{1/4} Na_{1/6} Mn_{6/12} Sn_{1/12} O₂ show that the invented material exhibits a significantly larger reversible capacity. An improvement in material stability is also observed when compared to NaNi_{0.5}Mn_{0.5}O₂ described in Komaba et al Adv. Funct. Mater. 2011, 21, 3859. Typically, NaNi_{0.5}Mn_{0.5}O₂ shows a reversible capacity of 140 mAh/g. In comparison, Na Ni_{1/4} Na_{1/6} Mn_{6/12} Sn_{1/12} O₂ has a reversible capacity of 190 mAh/g. It can also be seen from FIG. 2B that the invented material Na Ni_{1/4} Na_{1/6} Mn_{6/12} Sn_{1/12} O₂ demonstrates higher reversible capacity and stability over a larger potential window than the prior art material NaNi_{0.5}Mn_{0.5}O₂. As can be seen in FIG. 2(B) the invented Na Ni_{1/4} Na_{1/6} Mn_{6/12} Sn_{1/12} O₂ demonstrates significant reversible capacity and stability in the potential window 1.5 to 4.3 V Vs Na/Na+. This stability range is significantly wider than that observed for the prior art material NaNi_{0.5}Mn_{0.5}O₂ that demonstrates optimum reversible capacity in the potential window 2.2 to 3.8 V Vs Na/Na⁺. This yields a higher average intercalation potential in the invented material over the prior art material which increases the utility of these compounds for application in rechargeable batteries. In FIG. 2(C) it can also be seen that the invented material Na Ni_{1/4} Na_{1/6} Mn_{4/12} Ti_{2/12} Sn_{1/12} O₂ demonstrates reasonable capacity retention over the first ten electrochemical cycles.

The Electrochemical Properties of Na Ni_{1/4} Na_{1/6} Ti_{1/12} Mn_{5/12} Sn_{1/12}O₂ Prepared in Example 3.

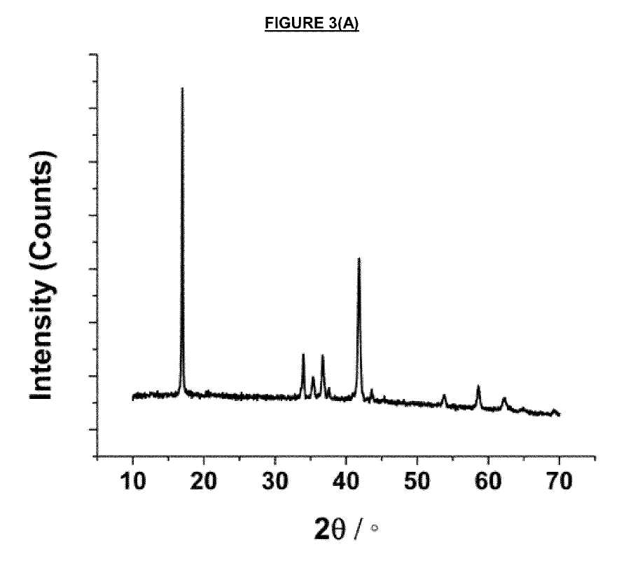

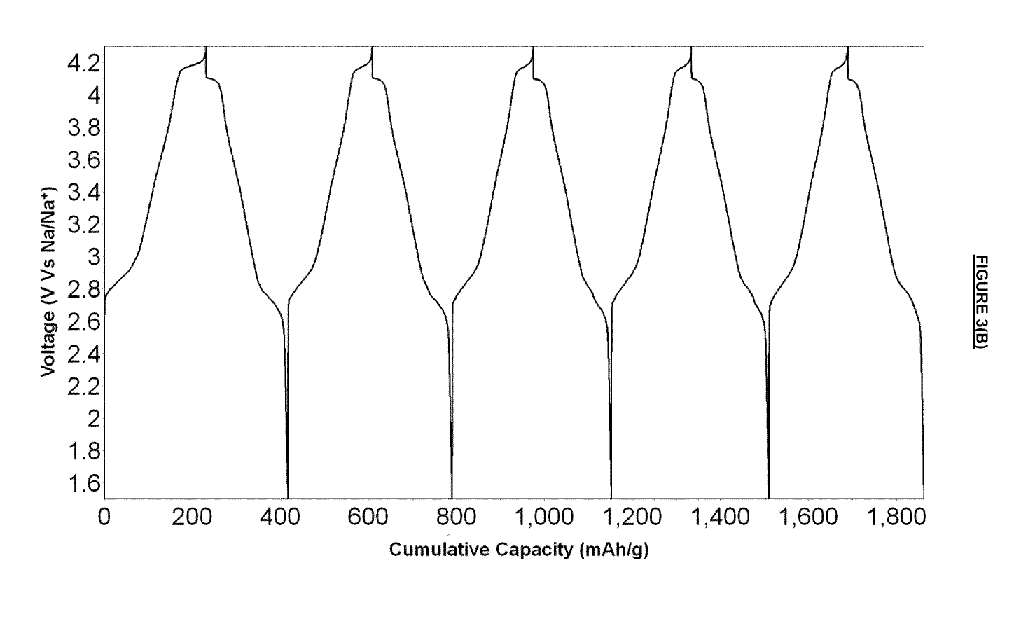

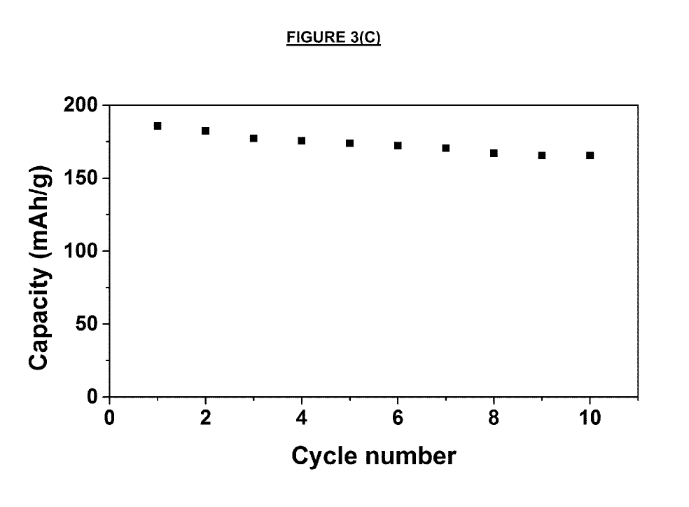

FIG. 3(A) shows the powder X-ray diffraction pattern of the target compound from Example 3 of Table 1, Na Ni_{1/4} Na_{1/6} Ti_{1/12} Mn_{5/12} Sn_{1/12} O₂ having an O3 layered oxide phase. The target compound of Example 3 was analysed using the X-ray diffraction technique described above. FIG. 3(A) shows the intensity (counts) versus the range of 10°-70° 2θ.

The data shown in FIGS. 3(B) and 3(C) are derived from constant current cycling data for a Na Ni_{1/4} Na_{1/6} Ti_{1/12} Mn_{5/12} Sn_{1/12} O₂ cathode active material in a Na metal half cell where this cathode material was cycled against a thin film of Na metal. The electrolyte used was a 0.5 M solution of NaClO₄ in propylene carbonate (PC). The constant current data was collected at an approximate current of 10 mA/g between voltage limits of 1.50 and 4.30 V Vs Na/Na⁺ and the testing was undertaken at room temperature (i.e., 22° C.). The testing was carried out in an analogous manner to that reported for Example 1 and Example 2. FIG. 3(B) shows the cell voltage profile (Cell Voltage [V] versus Cumulative Cathode Specific Capacity (milliamp hours per gram [mAh/g])) for the first five charge/discharge cycles of Na Ni_{1/4} Na_{1/6} Ti_{1/12} Mn_{5/12} Sn_{1/12} O₂ cycled in a sodium metal cell. FIG. 3(C) shows the constant current cycle life profile (i.e. the relationship between cathode specific capacity for discharge [mAh/g] and cycle number for a Na Ni_{1/4} Na_{1/6} Ti_{1/12} Mn_{5/12} Sn_{1/12} O₂ cathode).

As can be seen in FIG. 3(B) the invented material Na Ni_{1/4} Na_{1/6} Ti_{1/12} Mn_{5/12} Sn_{1/12} O₂ demonstrates significant reversible capacity and stability in the potential window 1.5 to 4.3 V Vs Na/Na+ consistent with the characterisation presented for Example 1 and Example 2. This stability range is significantly wider than that observed for the prior art material NaNi_{0.5}Mn_{0.5}O₂ which demonstrates optimum reversible capacity in the potential window 2.2 to 3.8 V Vs Na/Na⁺. This yields a higher average intercalation potential in the invented material over the prior art material which increases the utility of these compounds for application in rechargeable batteries. In FIG. 3(C) it can also be seen that the invented material Na Ni_{1/4} Na_{1/6} Ti_{1/12} Mn_{5/12} Sn_{1/12} O₂ demonstrates reasonable capacity retention over the first ten electrochemical cycles.

The Electrochemical Properties of Na Ni_{1/4} Na_{1/6}Ti_{1/12} Mn_{11/24} Sn_{1/24} O₂Prepared in Example 4.

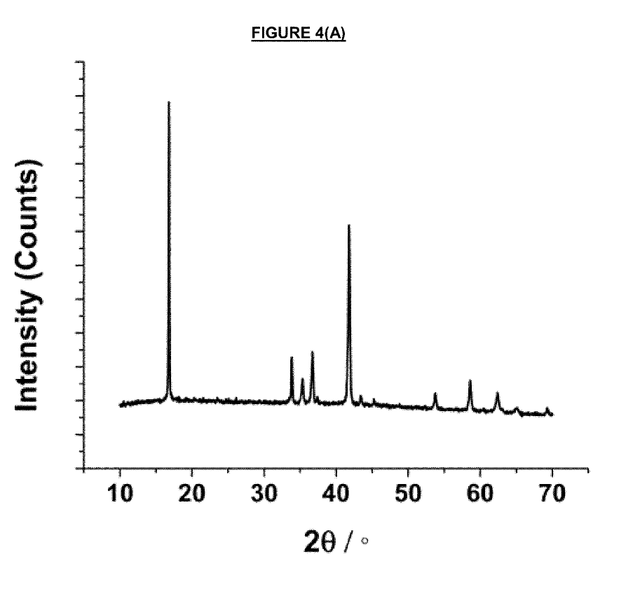

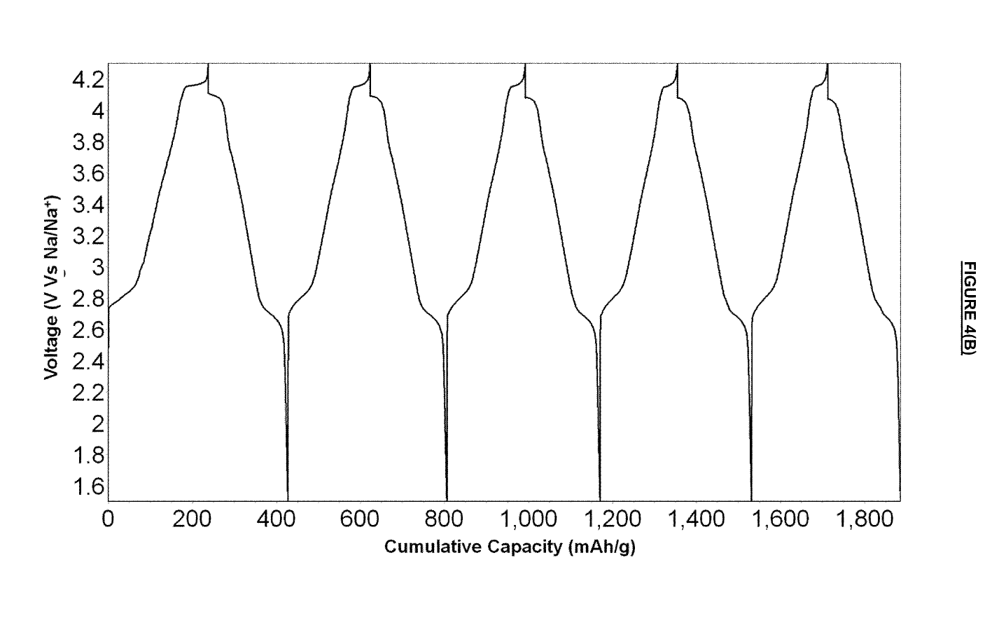

FIG. 4(A) shows the powder X-ray diffraction pattern of the target compound from Example 4 of Table 1, Na Ni_{1/4} Na_{1/6}Ti_{1/12} Mn_{11/24} Sn_{1/24} O₂ having an O3 layered oxide phase. The target compound of Example 4 was analysed using the X-ray diffraction technique described above. FIG. 4(A) shows the intensity (counts) versus the range of 10°-70° 2θ.

The data shown in FIGS. 4(B) and 4(C) are derived from constant current cycling data for a Na Ni_{1/4} Na_{1/6} Mn_{6/12} Sn_{1/12} O₂ cathode active material in a Na metal half cell where this cathode material was cycled against a thin film of Na metal. The electrolyte used was a 0.5 M solution of NaClO₄ in propylene carbonate (PC). The constant current data was collected at an approximate current of 10 mA/g between voltage limits of 1.50 and 4.30 V Vs Na/Na⁺ and the testing was undertaken at room temperature (i.e., 22° C.). The testing was carried out in an analogous manner to that reported for Example 1. FIG. 4(B) shows the cell voltage profile (Cell Voltage [V] versus Cumulative Cathode Specific Capacity (milliamp hours per gram [mAh/g])) for the first five charge/discharge cycles of Na Ni_{1/4} Na_{1/6} Mn_{6/12} Sn_{1/12} O₂ cycled in a sodium metal cell. FIG. 4(C) shows the constant current cycle life profile (i.e. the relationship between cathode specific capacity for discharge [mAh/g] and cycle number for a Na Ni_{1/4} Na_{1/6} Mn_{6/12} Sn_{1/12} O₂ cathode).

It can be seen from FIG. 4(B) and FIG. 4(C) that the material Na Ni_{1/4} Na_{1/6} Mn_{6/12} Sn_{1/12} O₂ has a reversible capacity of 190 mAh/g. The material shows similar electrochemical properties to those described for Example 1, Example 2 and Example 3 of this application. It is also clear from FIG. 4 (C) that the example material Na Ni_{1/4} Na_{1/6} Mn_{6/12} Sn_{1/12} O₂ demonstrates reasonable capacity retention when charge and discharged between 1.50 and 4.30 V Vs Na/Na⁺.

The Electrochemical Properties of Na Ni_{1/4} Na_{1/6} Ti_{1/24} Mn_{6/12} Sn_{1/24} O₂ Prepared in Example 5.

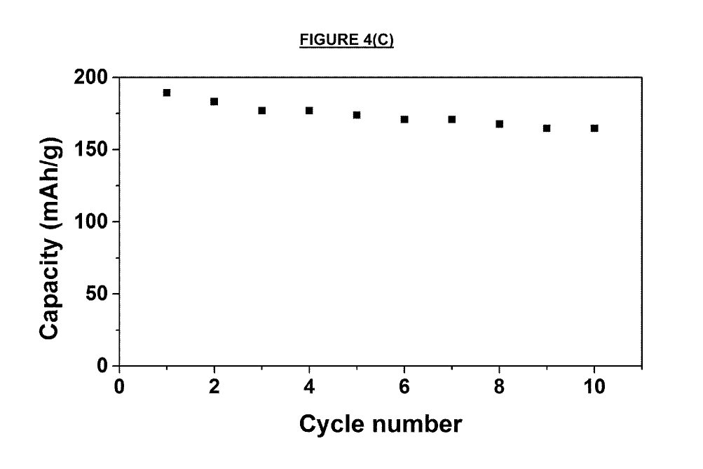

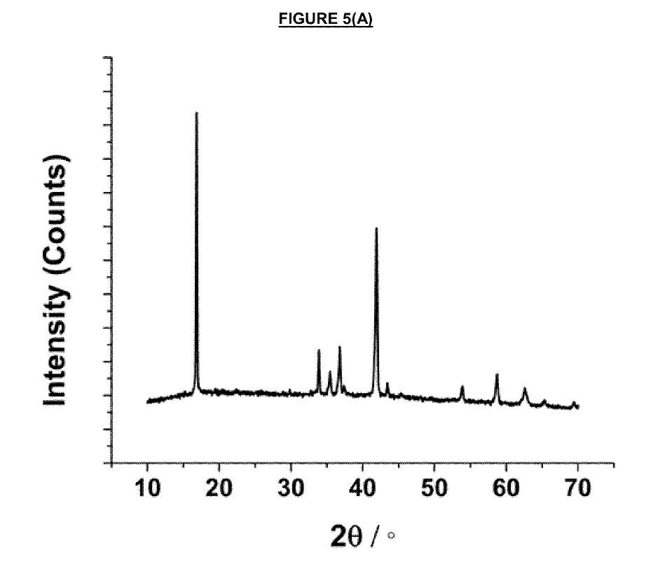

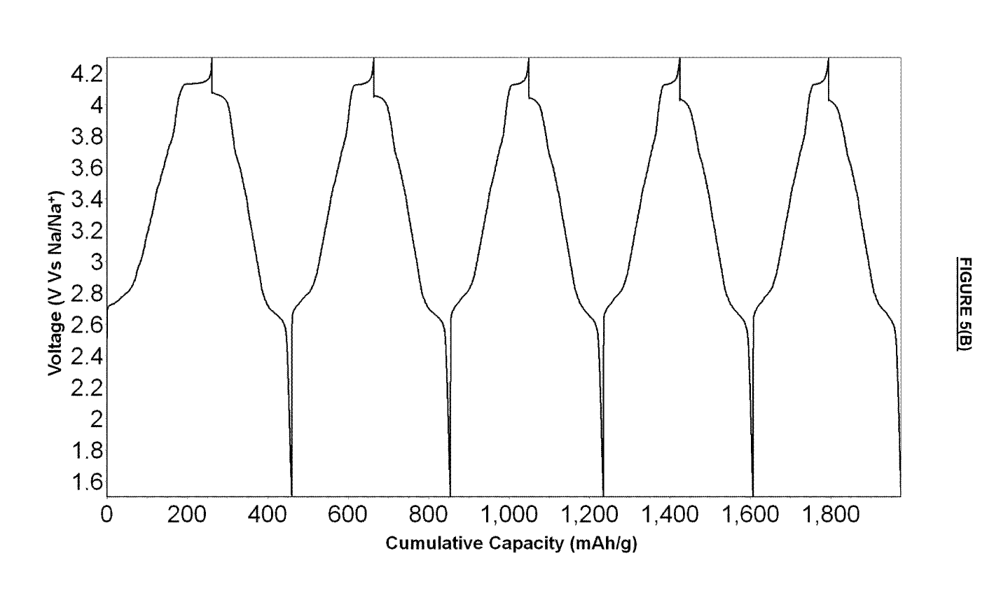

FIG. 5(A) shows the powder X-ray diffraction pattern of the target compound from Example 5 of Table 1, Na Ni_{1/4} Na_{1/6} Ti_{1/24} Mn_{6/12} Sn_{1/24} O₂ having an O3 layered oxide phase. The target compound of Example 5 was analysed using the X-ray diffraction technique described above. FIG. 5(A) shows the intensity (counts) versus the range of 10°-70° 2°.

The data shown in FIGS. 5(B) and 5(C) are derived from constant current cycling data for a Na Ni_{1/4} Na_{1/6} Mn_{6/12} Sn_{1/12} O₂ cathode active material in a Na metal half cell. This data was collected as described for Example 1 to Example 4 inclusive. The constant current data was collected at an approximate current of 10 mA/g between voltage limits of 1.50 and 4.30 V Vs Na/Na⁺ and the testing was undertaken at room temperature (i.e., 22° C.). FIG. 5(B) shows the cell voltage profile (Cell Voltage [V] versus Cumulative Cathode Specific Capacity (milliamp hours per gram [mAh/g])) for the first five charge/discharge cycles of Na Ni_{1/4} Na_{1/6} Ti_{1/24} Mn_{6/12} Sn_{1/24} O₂ cycled in a sodium metal cell. FIG. 5(C) shows the constant current cycle life profile (i.e. the relationship between cathode specific capacity for discharge [mAh/g] and cycle number for a Na Ni_{1/4} Na_{1/6} Mn_{6/12} Sn_{1/12} O₂ cathode).

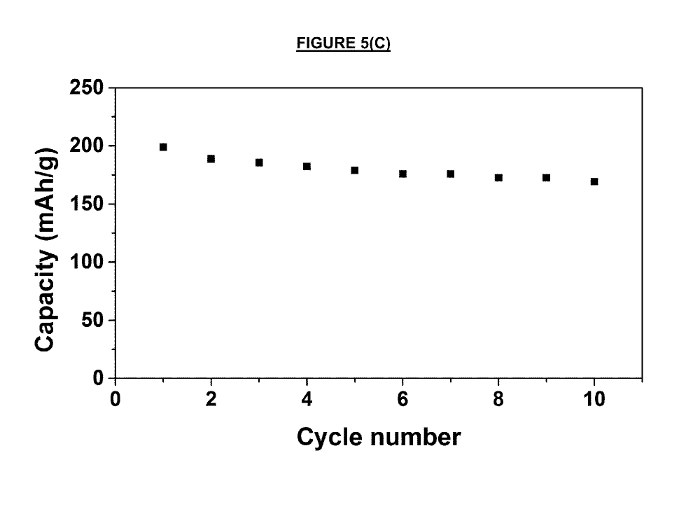

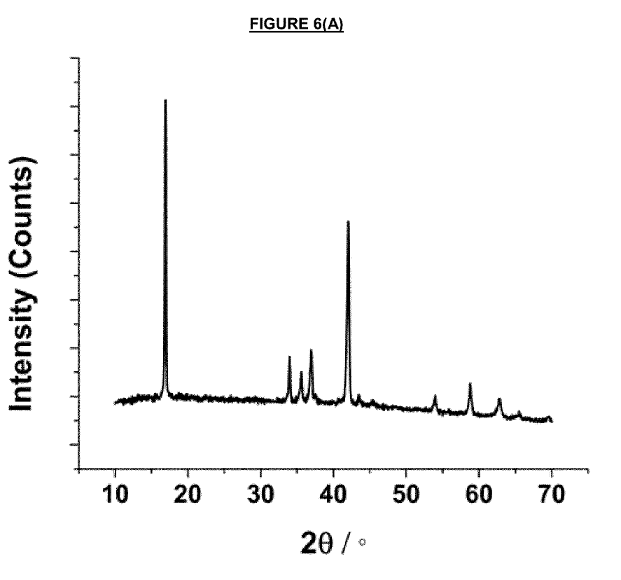

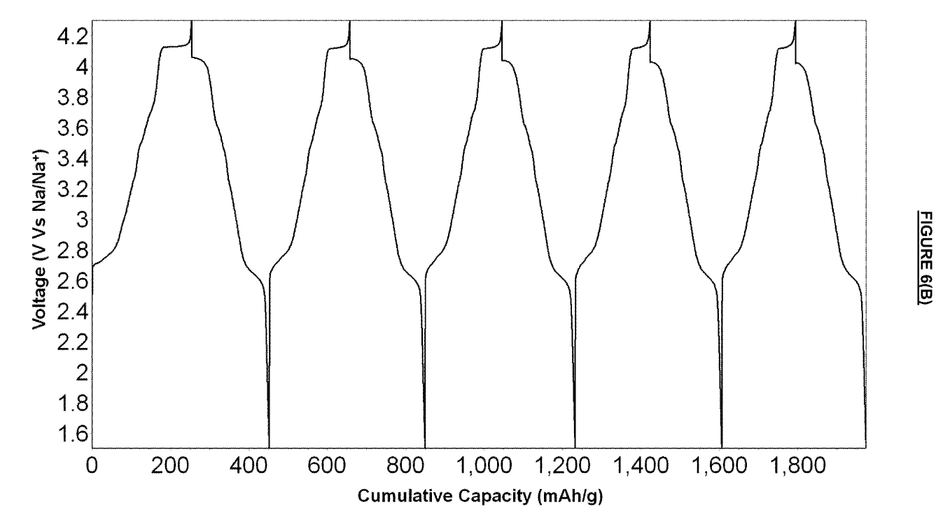

It can be seen from FIG. 5(B) and FIG. 5(C) that the material Na Ni_{1/4} Na_{1/6} Ti_{1/24} Mn_{6/12} Sn_{1/24} O₂ has a reversible capacity of 200 mAh/g. The material shows similar electrochemical properties to those described for Example 1, Example 2 and Example 3 of this application. It is also clear from FIG. 6 (C) that the example material Na Ni_{1/4} Na_{1/6} Ti_{1/24} Mn_{6/12} Sn_{1/24} O₂ demonstrates reasonable capacity retention when charge and discharged between 1.50 and 4.30 V Vs Na/Na⁺. Observation of the properties of the material Na Ni_{1/4} Na_{1/6} Ti_{1/24} Mn_{6/12} Sn_{1/24} O₂ are consistent with those made for previous examples used in this application.

The Electrochemical Properties of Na Ni_{1/4} Na_{1/6} Mn_{13/24} Sn_{1/24} O₂ Prepared in Example 6.

FIG. 6(A) shows the powder X-ray diffraction pattern of the target compound from Example 6 of Table 1, Na Ni_{1/4} Na_{1/6} Mn_{13/24} Sn_{1/24} O₂ having an O3 layered oxide phase. The target compound of Example 6 was analysed using the X-ray diffraction technique described above. FIG. 6(A) shows the intensity (counts) versus the range of 10°-70° 2θ.

The data shown in FIGS. 6(B) and 6(C) are derived from constant current cycling data for a Na Ni_{1/4} Na_{1/6} Mn_{13/24} Sn_{1/24} O₂ cathode active material in a Na metal half cell. This data was collected as described for Example 1 to Example 5 inclusive. The constant current data was collected at an approximate current of 10 mA/g between voltage limits of 1.50 and 4.30 V Vs Na/Na⁺ and the testing was undertaken at room temperature (i.e., 22° C.). FIG. 6(B) shows the cell voltage profile (Cell Voltage [V] versus Cumulative Cathode Specific Capacity (milliamp hours per gram [mAh/g])) for the first five charge/discharge cycles of Na Ni_{1/4} Na_{1/6} Mn_{13/24} Sn_{1/24} O₂ cycled in a sodium metal cell. FIG. 6(C) shows the constant current cycle life profile (i.e. the relationship between cathode specific capacity for discharge [mAh/g] and cycle number for a Na Ni_{1/4} Na_{1/6} Mn_{13/24} Sn_{1/24} O₂ cathode).

It can be seen from FIG. 6(B) and FIG. 6(C) that the material Na Ni_{1/4} Na_{1/6} Mn_{13/24} Sn_{1/24} O₂ has a reversible capacity of ca. 200 mAh/g. The material shows similar electrochemical properties to those described for Example 1, Example 2 and Example 3 of this application. It is also clear from FIG. 6 (C) that the example material Na Ni_{1/4} Na_{1/6} Mn_{13/24} Sn_{1/24} O₂ demonstrates reasonable capacity retention when charge and discharged between 1.50 and 4.30 V Vs Na/Nat. Observation of the properties of the material Na Ni_{1/4} Na_{1/6} Mn_{13/24} Sn_{1/24} O₂ are consistent with those made for previous examples used in this application.

The Electrochemical Properties of Na Ni_{1/4} Na_{1/6} Ti_{4/24} Mn_{8/24} Sn_{1/12} O₂Prepared in Example 7.

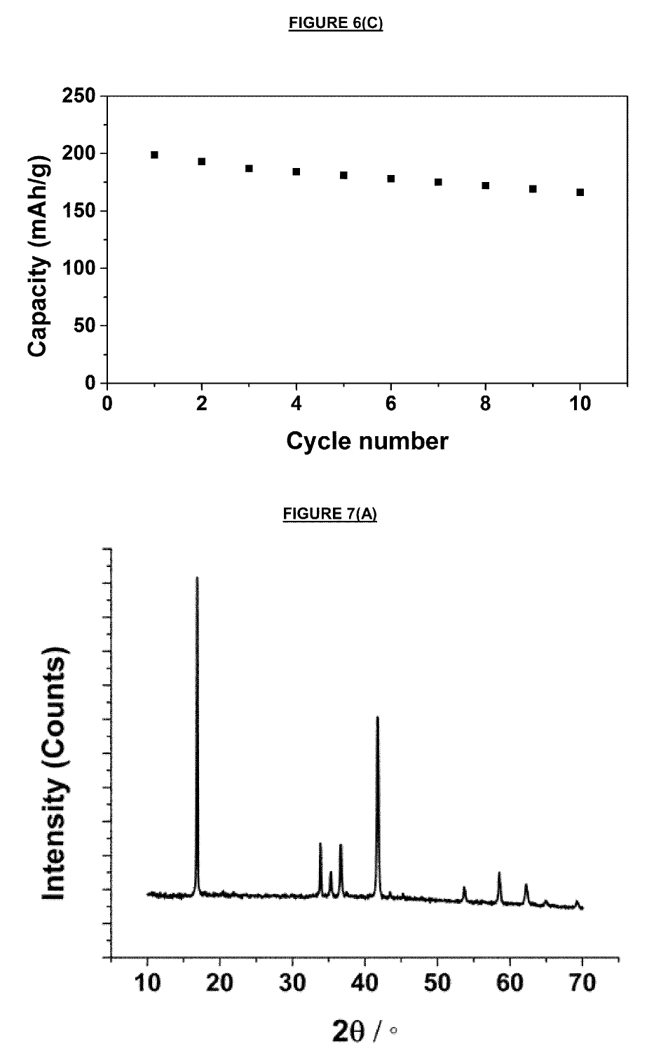

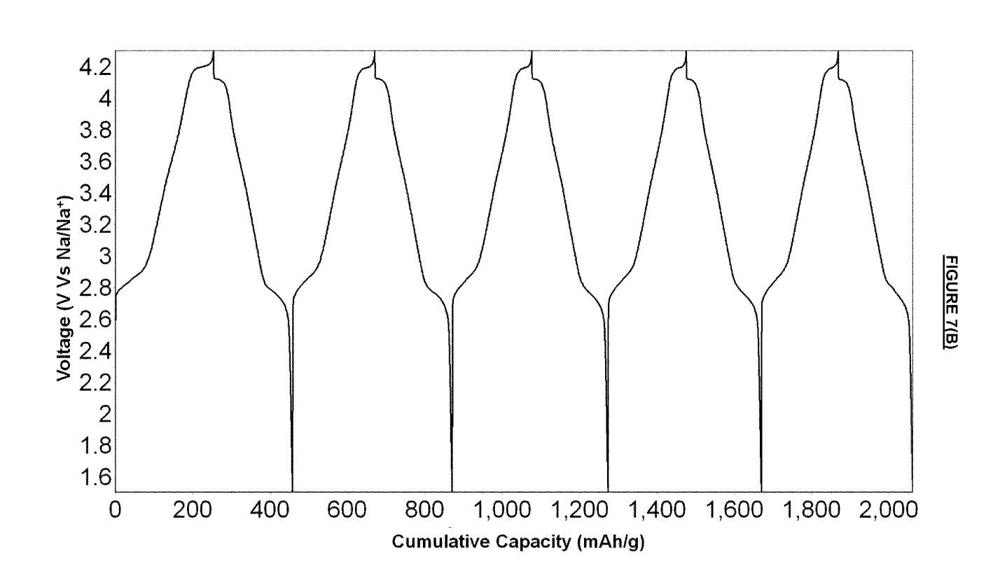

FIG. 7(A) shows the powder X-ray diffraction pattern of the target compound from Example 7 of Table 1, Na Ni_{1/4} Na_{1/6} Ti_{4/24} Mn_{8/24} Sn_{1/12} O₂ having an O3 layered oxide phase. The target compound of Example 7 was analysed using the X-ray diffraction technique described above. FIG. 7(A) shows the intensity (counts) versus the range of 10°-70° 2θ.

The data shown in FIGS. 7(B) and 7(C) are derived from constant current cycling data for a Na Ni_{1/4} Na_{1/6} Ti_{4/24} Mn_{8/24} Sn_{1/12} O₂ cathode active material in a Na metal half cell. This data was collected as described for Example 1 to Example 6 inclusive. The constant current data was collected at an approximate current of 10 mA/g between voltage limits of 1.50 and 4.30 V Vs Na/Na⁺ and the testing was undertaken at room temperature (i.e., 22° C.). FIG. 7(B) shows the cell voltage profile (Cell Voltage [V] versus Cumulative Cathode Specific Capacity (milliamp hours per gram [mAh/g])) for the first five charge/discharge cycles of Na Ni_{1/4} Na_{1/6} Ti_{4/24} Mn_{8/24} Sn_{1/12} O₂ cycled in a sodium metal cell. FIG. 7(C) shows the constant current cycle life profile (i.e. the relationship between cathode specific capacity for discharge [mAh/g] and cycle number for a Na Ni_{1/4} Na_{1/6} Ti_{4/24} Mn_{8/24} Sn_{1/12} O₂ cathode).

It can be seen from FIG. 7(B) and FIG. 7(C) that the material Na Ni_{1/4} Na_{1/6} Ti_{4/24} Mn_{8/24} Sn_{1/12} O₂ has a reversible capacity of ca. 208 mAh/g. The material shows similar electrochemical properties to those described for Example 3, Example 4 and Example 5 of this application. It is also clear from FIG. 7 (C) that the example material Na Ni_{1/4} Na_{1/6} Ti_{4/24} Mn_{8/24} Sn_{1/12} O₂ demonstrates reasonable capacity retention when charge and discharged between 1.50 and 4.30 V Vs Na/Na⁺. Observation of the properties of the material Na Ni_{1/4} Na_{1/6} Ti_{4/24} Mn_{8/24} Sn_{1/12} O₂ are consistent with those made for previous examples used in this application.

The Electrochemical Properties of Na Ni_{1/4} Na_{1/6} Ti_{3/12} Mn_{7/24} Sn_{1/24} O₂Prepared in Example 8.

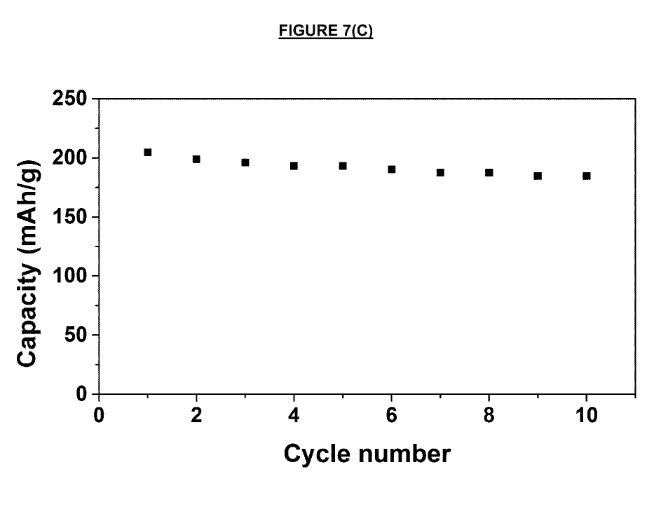

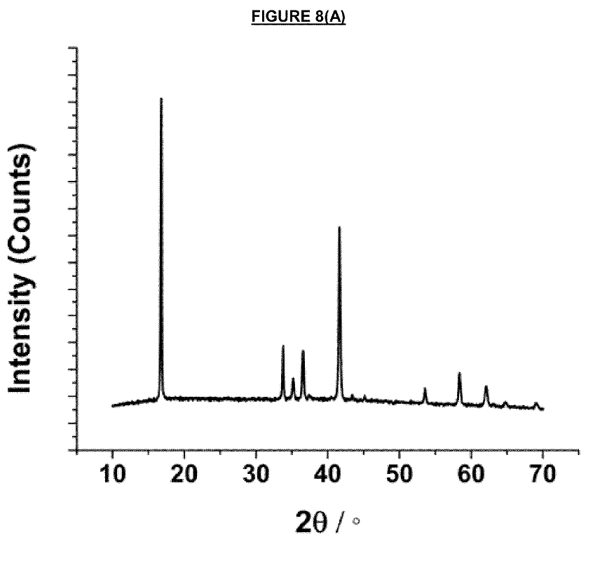

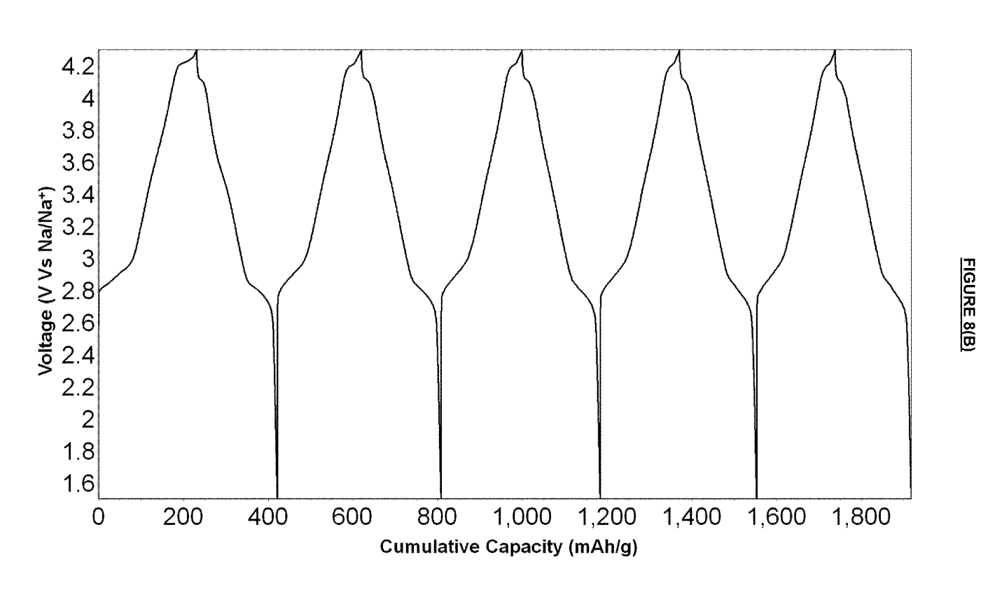

FIG. 8(A) shows the powder X-ray diffraction pattern of the target compound from Example 8 of Table 1, Na Ni_{1/4} Na_{1/6} Ti_{3/12} Mn_{7/24} Sn_{1/24} O₂ having an O3 layered oxide phase. The target compound of Example 8 was analysed using the X-ray diffraction technique described above. FIG. 8(A) shows the intensity (counts) versus the range of 10°-70° 2θ.

The data shown in FIGS. 8(B) and 8(C) are derived from constant current cycling data for a Na Ni_{1/4} Na_{1/6} Ti_{3/12} Mn_{7/24} Sn_{1/24} O₂ cathode active material in a Na metal half cell. This data was collected as described for Example 1 to Example 7 inclusive. The constant current data was collected at an approximate current of 10 mA/g between voltage limits of 1.50 and 4.30 V Vs Na/Na⁺ and the testing was undertaken at room temperature (i.e., 22° C.). FIG. 8(B) shows the cell voltage profile (Cell Voltage [V] versus Cumulative Cathode Specific Capacity (milliamp hours per gram [mAh/g])) for the first five charge/discharge cycles of Na Ni_{1/4} Na_{1/6} Ti_{3/12} Mn_{7/24} Sn_{1/24} O₂ cycled in a sodium metal cell. FIG. 8(C) shows the constant current cycle life profile (i.e. the relationship between cathode specific capacity for discharge [mAh/g] and cycle number for a Na Ni_{1/4} Na_{1/6} Ti_{3/12} Mn_{7/24} Sn_{1/24} O₂ cathode).

It can be seen from FIG. 8(B) and FIG. 8(C) that the material Na Ni_{1/4} Na_{1/6} Ti_{3/12} Mn_{7/24} Sn_{1/24} O₂ has a reversible capacity of ca. 190 mAh/g. The material shows similar electrochemical properties to those described for Example 5, Example 6 and Example 7 of this application. It is also clear from FIG. 8 (C) that the example material Na Ni_{1/4} Na_{1/6} Ti_{3/12} Mn_{7/24} Sn_{1/24} O₂ demonstrates reasonable capacity retention when charge and discharged between 1.50 and 4.30 V Vs Na/Na⁺. Observation of the properties of the material Na Ni_{1/4} Na_{1/6} Ti_{3/12} Mn_{7/24} Sn_{1/24} O₂ are consistent with those made for previous examples used in this application.

The Electrochemical properties of Na Ni_{1/4} Na_{1/12} Li_{1/12} Mn_{13/24} Sn_{1/24} O₂ Prepared in Example 9.

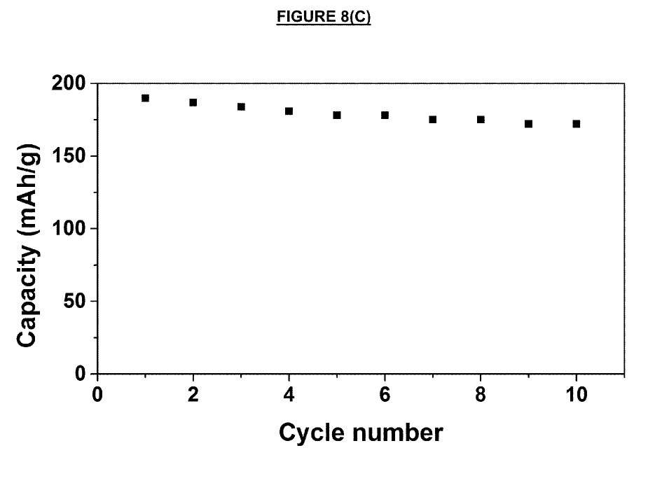

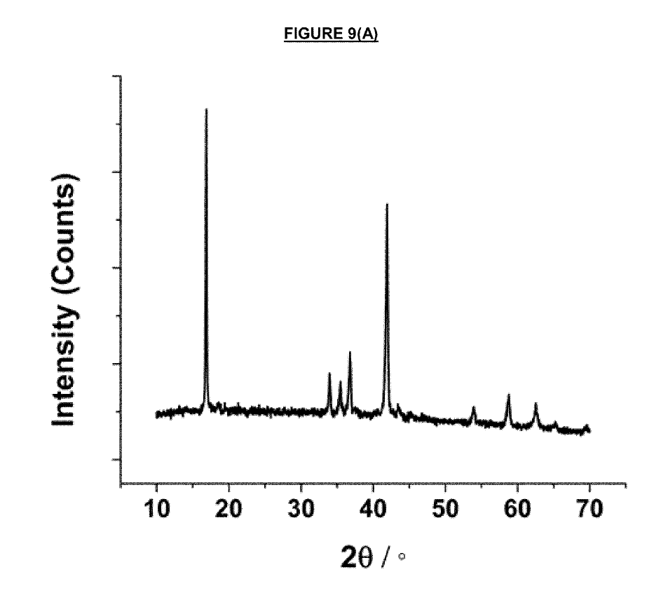

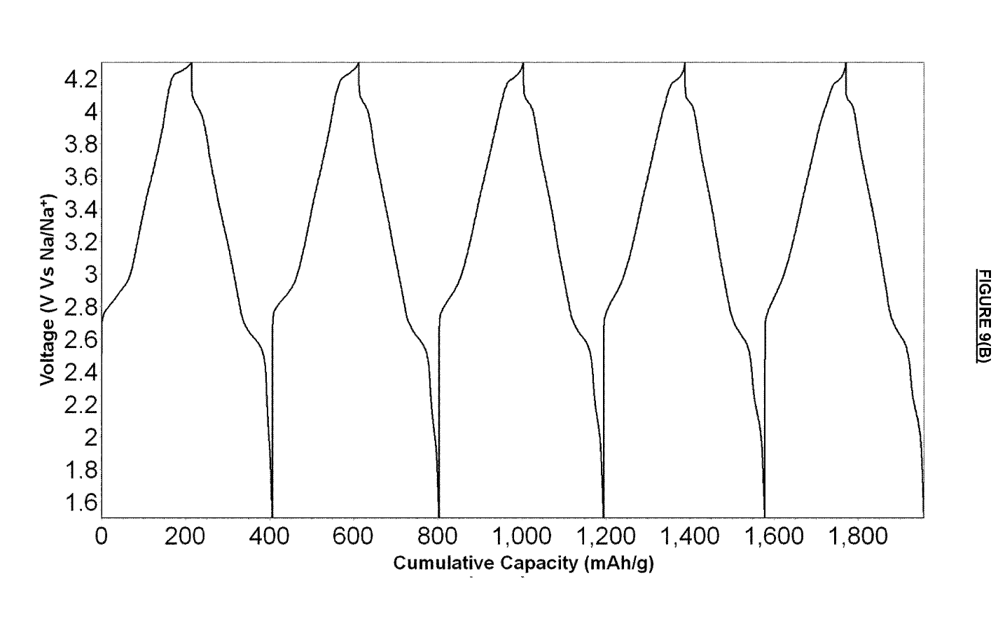

FIG. 9(A) shows the powder X-ray diffraction pattern of the target compound from Example 9 of Table 1, Na Ni_{1/4} Na_{1/12} Li_{1/12} Mn_{13/24} Sn_{1/24} O₂ having an O3 layered oxide phase. The target compound of Example 9 was analysed using the X-ray diffraction technique described above. This material demonstrates that partial substitution of Li for Sodium in the material leads to the formation of an O3 layered oxide phase. FIG. 9(A) shows the intensity (counts) versus the range of 10°-70° 2θ.

The data shown in FIGS. 9(B) and 9(C) are derived from constant current cycling data for a Na Ni_{1/4} Na_{1/12} Li_{1/12} Mn_{13/24} Sn_{1/24} O₂ cathode active material in a Na metal half cell. This data was collected as described for Example 1 to Example 8 inclusive. The constant current data was collected at an approximate current of 10 mA/g between voltage limits of 1.50 and 4.30 V Vs Na/Na⁺ and the testing was undertaken at room temperature (i.e., 22° C.). FIG. 9(B) shows the cell voltage profile (Cell Voltage [V] versus Cumulative Cathode Specific Capacity (milliamp hours per gram [mAh/g])) for the first five charge/discharge cycles of Na Ni_{1/4} Na_{1/12} Li_{1/12} Mn_{13/24} Sn_{1/24} O₂ cycled in a sodium metal cell. FIG. 9(C) shows the constant current cycle life profile (i.e. the relationship between cathode specific capacity for discharge [mAh/g] and cycle number for a Na Ni_{1/4} Na_{1/12} Li_{1/12} Mn_{13/24} Sn_{1/24} O₂ cathode).

It can be seen from FIG. 9(B) and FIG. 9(C) that the material Na Ni_{1/4} Na_{1/12} Li_{1/12} Mn_{13/24} Sn_{1/24} O₂ has a reversible capacity of ca. 191 mAh/g. The material shows similar electrochemical properties to those described for Example 6, Example 7 and Example 8 of this application even with partial substitution of Li into the materials structure. It is also clear from FIG. 9 (C) that the example material Na Ni_{1/4} Na_{1/12} Li_{1/12} Mn_{13/24} Sn_{1/24} O₂ demonstrates reasonable capacity retention when charge and discharged between 1.50 and 4.30 V Vs Na/Na⁺. Observation of the properties of the material Na Ni_{1/4} Na_{1/12} Li_{1/12} Mn_{13/24} Sn_{1/24} O₂ are consistent with those made for previous examples used in this application even upon partial substitution of Li for Na in the structure.

The Electrochemical Properties of Na Ni_{1/4} Na_{1/6} Mn_{2/12} Ti_{4/12} Sn_{1/12} O₂Prepared in Example 10

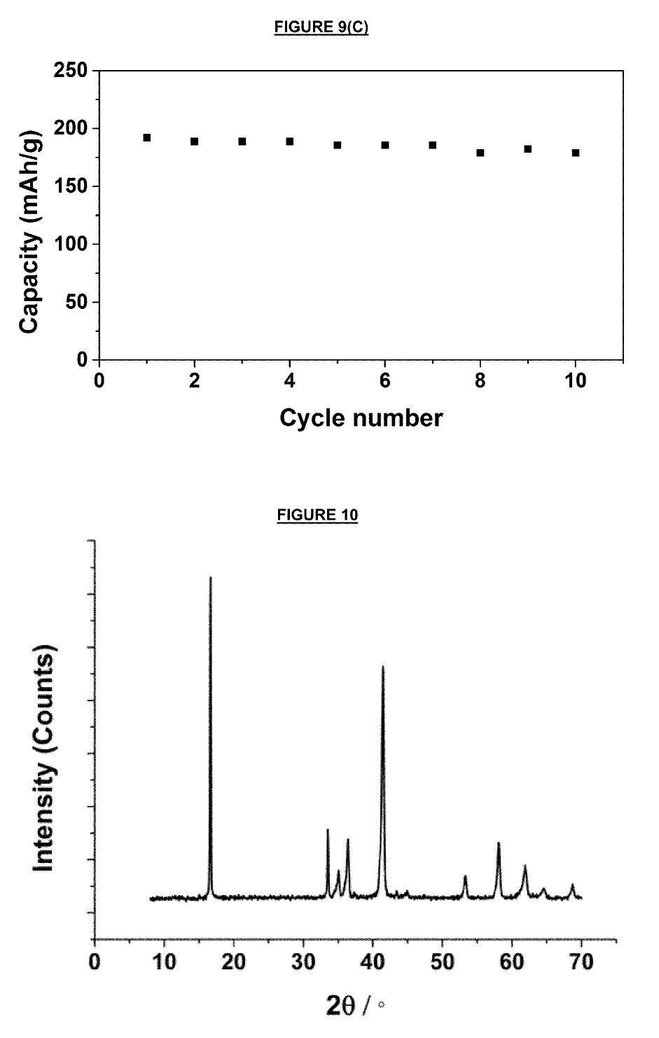

Na Ni_{1/4} Na_{1/6} Mn_{2/12} Ti_{4/12} Sn_{1/12} O₂ was prepared according to Example 10 by a solid state reaction. The material has an O3 type layered oxide structure as indicated by the obtained powder X-ray diffraction pattern shown in FIG. 10. When Na Ni_{1/4} Na_{1/6} Mn_{2/12} Ti_{4/12} Sn_{1/12} O₂ was tested in a sodium metal anode cell an initial discharge capacity of 158 mAh/g at an average potential of 3.20 V Vs Na/Na⁺ was observed as summarised in Table 2. This is a higher than expected capacity based on conventional calculation. The constant current data shown in Table 2 was collected at an approximate current of 10 mA/g between voltage limits of 1.50 and 4.30 V Vs Na/Na⁺ and the testing was undertaken at room temperature (i.e., 22° C.) consistent with the characterisation of all other materials of the present invention.

The Electrochemical Properties of Na Ni_{1/4} Na_{1/6} Mn_{1/12} Ti_{4/12} Sn_{2/12} O₂ Prepared in Example 11

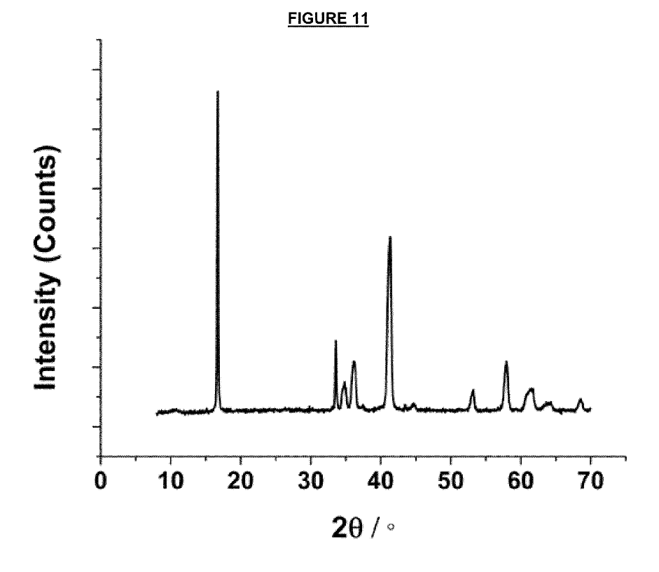

Na Ni_{1/4} Na_{1/6} Mn_{1/12} Ti_{4/12} Sn_{2/12} O₂ was prepared according to Example 11 by a solid state reaction. The material has an O3 type layered oxide structure as indicated by the obtained powder X-ray diffraction pattern shown in FIG. 11. When Na Ni_{1/4} Na_{1/6} Mn_{1/12} Ti_{4/12} Sn_{2/12} O₂ was tested in a sodium metal anode cell an initial discharge capacity of 150 mAh/g at an average potential of 3.23 V Vs Na/Na⁺ was observed as summarised in Table 2. This is a higher than expected capacity based on conventional calculation. The constant current data shown in Table 2 was collected at an approximate current of 10 mA/g between voltage limits of 1.50 and 4.30 V Vs Na/Na⁺ and the testing was undertaken at room temperature (i.e., 22° C.) consistent with the characterisation of all other materials of the present invention.

The Electrochemical Properties of Na Ni_{1/4} Na_{1/6} Mn_{2/12} Ti_{3/12} Sn_{2/12} O₂Prepared in Example 12

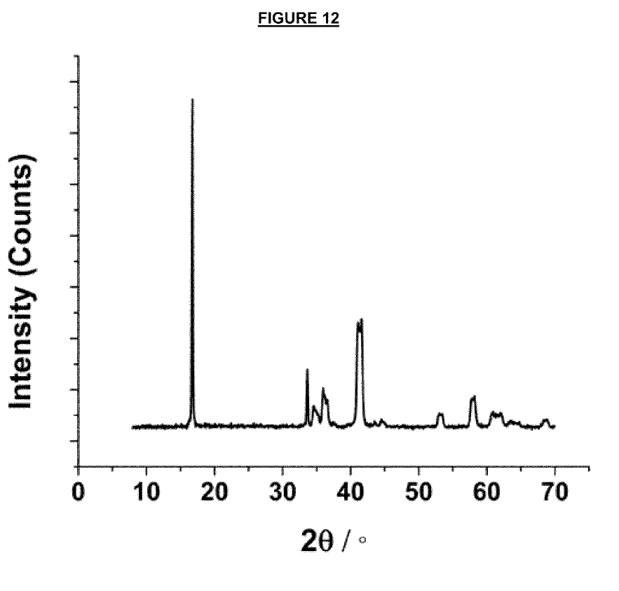

Na Ni_{1/4} Na_{1/6} Mn_{2/12} Ti_{3/12} Sn_{2/12} O₂ was prepared according to Example 12 by a solid state reaction. The material has an O3 type layered oxide structure as indicated by the obtained powder X-ray diffraction pattern shown in FIG. 12. When Na Ni_{1/4} Na_{1/6} Mn_{2/12} Ti_{3/12} Sn_{2/12} O₂ was tested in a sodium metal anode cell an initial discharge capacity of 148 mAh/g at an average potential of 3.16 V Vs Na/Na⁺ was observed as summarised in Table 2. This is a higher than expected capacity based on conventional calculation. The constant current data shown in Table 2 was collected at an approximate current of 10 mA/g between voltage limits of 1.50 and 4.30 V Vs Na/Nat and the testing was undertaken at room temperature (i.e., 22° C.) consistent with the characterisation of all other materials of the present invention.

The Electrochemical Properties of Na Ni_{1/4} Na_{1/6} Mn_{2/12} Ti_{2/12} Sn_{3/12} O₂ Prepared in Example 13

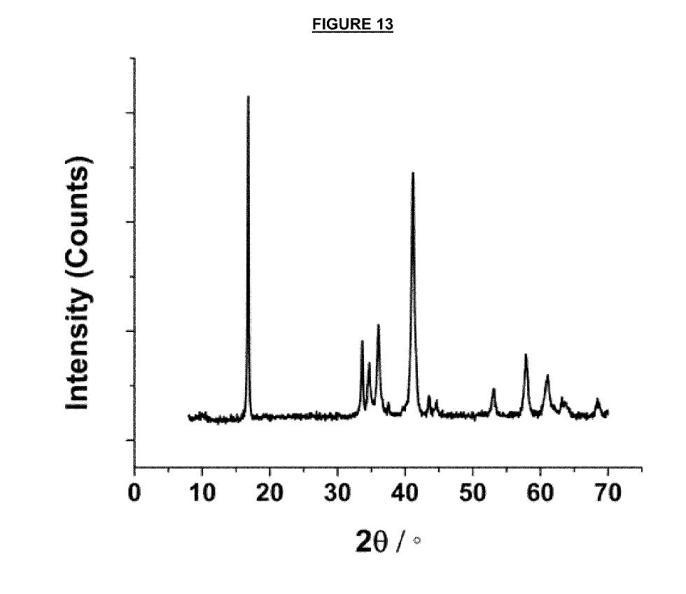

Na Ni_{1/4} Na_{1/6} Mn_{2/12} Ti_{2/12} Sn_{3/12} O₂ was prepared according to Example 13 by a solid state reaction. The material has an O3 type layered oxide structure as indicated by the obtained powder X-ray diffraction pattern shown in FIG. 13. When Na Ni_{1/4} Na_{1/6} Mn_{2/12} Ti_{2/12} Sn_{3/12} O₂ was tested in a sodium metal anode cell an initial discharge capacity of 152 mAh/g at an average potential of 3.00 V Vs Na/Na⁺ was observed as summarised in Table 2. This is a higher than expected capacity based on conventional calculation. The constant current data shown in Table 2 was collected at an approximate current of 10 mA/g between voltage limits of 1.50 and 4.30 V Vs Na/Na⁺ and the testing was undertaken at room temperature (i.e., 22° C.) consistent with the characterisation of all other materials of the present invention.

The Electrochemical Properties Na Ni_{1/4} Na_{1/6} Ti_{1/12} Sn_{1/12} O₂ Prepared in Example 14

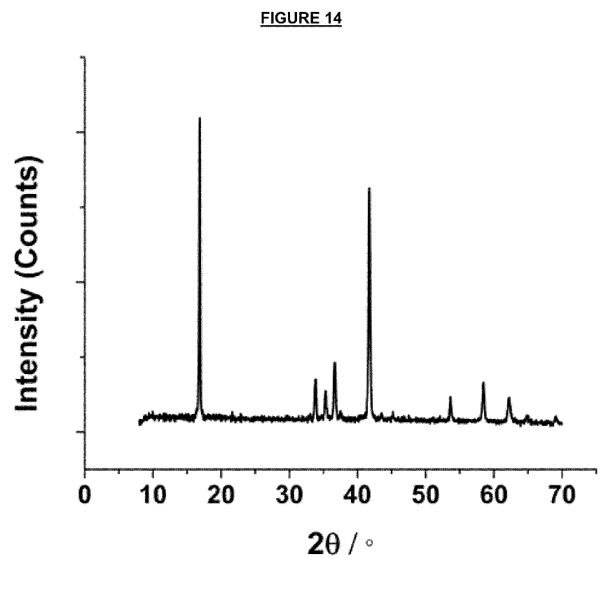

Na Ni_{1/4} Na_{1/6}Ti_{6/12} Sn_{1/12} O₂ was prepared according to Example 14 by a solid state reaction. The material has an O3 type layered oxide structure as indicated by the obtained powder X-ray diffraction pattern shown in FIG. 14. When Na Ni_{1/4} Na_{1/6}Ti_{6/12} Sn_{1/12} O₂ was tested in a sodium metal anode cell an initial discharge capacity of 142 mAh/g at an average potential of 3.21 V Vs Na/Na⁺ was observed as summarised in Table 2. This is a higher than expected capacity based on conventional calculation. The constant current data shown in Table 2 was collected at an approximate current of 10 mA/g between voltage limits of 1.50 and 4.30 V Vs Na/Na⁺ and the testing was undertaken at room temperature (i.e., 22° C.) consistent with the characterisation of all other materials of the present invention.

The Electrochemical Properties Na Ni_{1/4} Na_{1/6} Ti_{4/12} Sn_{1/12} O₂ Prepared in Example 15

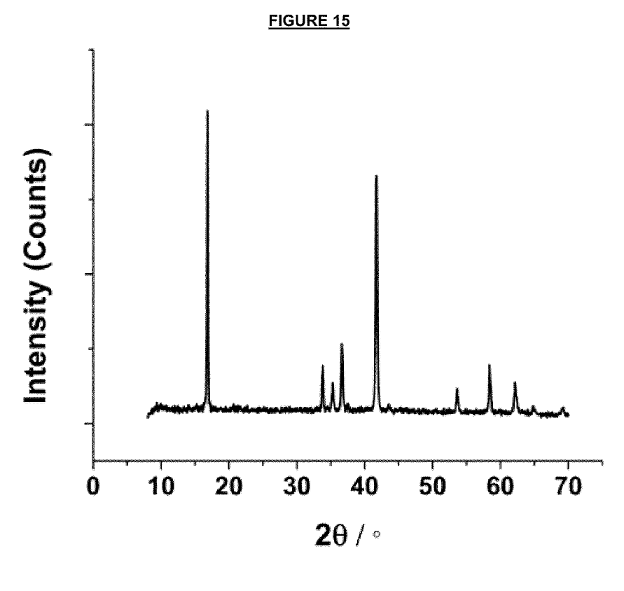

Na Ni_{1/4} Na_{1/6} Ti_{4/12} Sn_{3/12} O₂ was prepared according to Example 15 by a solid state reaction. The material has an O3 type layered oxide structure as indicated by the obtained powder X-ray diffraction pattern shown in FIG. 15. When Na Ni_{1/4} Na_{1/6}Ti_{4/12} Sn_{3/12} O₂ was tested in a sodium metal anode cell an initial discharge capacity of 118 mAh/g at an average potential of 3.19 V Vs Na/Na⁺ was observed as summarised in Table 2. This is a higher than expected capacity based on conventional calculation. The constant current data shown in Table 2 was collected at an approximate current of 10 mA/g between voltage limits of 1.50 and 4.30 V Vs Na/Na⁺ and the testing was undertaken at room temperature (i.e., 22° C.) consistent with the characterisation of all other materials of the present invention.

The Electrochemical Properties Na Ni_{1/4} Na_{1/6}Ti_{1/24}Mn_{13/24} Sn_{1/12} O₂Prepared in Example 16

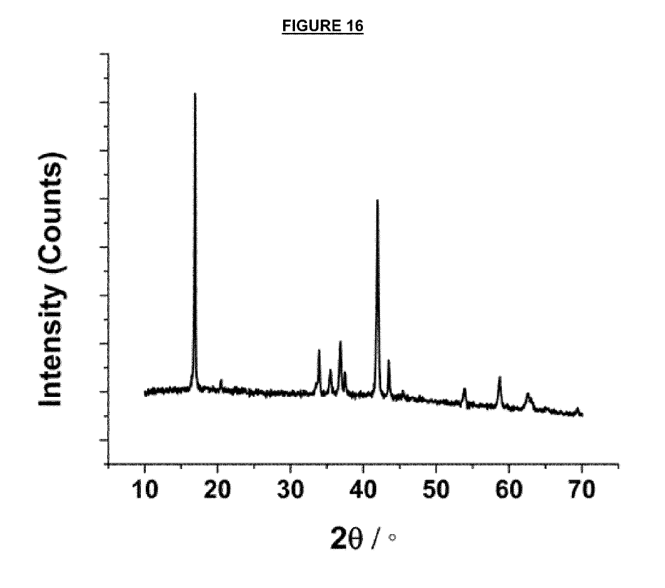

Na Ni_{1/4} Na_{1/6} Ti_{1/24} Mn_{13/24} Sn_{1/12} O₂ was prepared according to Example 16 by a solid state reaction. The material has an O3 type layered oxide structure as indicated by the obtained powder X-ray diffraction pattern shown in FIG. 16. When Na Ni_{1/4} Na_{1/6}Ti_{1/24} Mn_{13/24} Sn_{1/12} O₂ was tested in a sodium metal anode cell an initial discharge capacity of 175 mAh/g at an average potential of 3.19 V Vs Na/Na⁺ was observed as summarised in Table 2. This is a higher than expected capacity based on conventional calculation. The constant current data shown in Table 2 was collected at an approximate current of 10 mA/g between voltage limits of 1.50 and 4.30 V Vs Na/Na⁺ and the testing was undertaken at room temperature (i.e., 22° C.) consistent with the characterisation of all other materials of the present invention.

The Electrochemical Properties Na Ni_{1/4} Na_{1/6} Mn_{4/12} Sn_{3/12} O₂ Prepared in Example 17

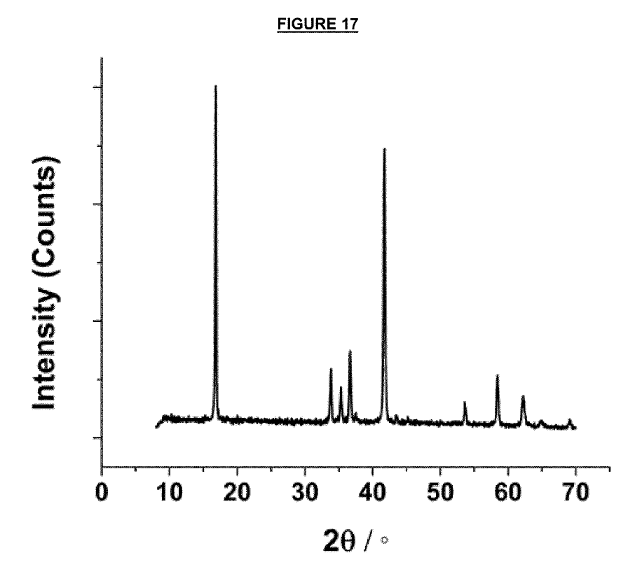

Na Ni_{1/4} Na_{1/6} Mn_{4/12} Sn_{3/12} O₂ was prepared according to Example 17 by a solid state reaction. The material has an O3 type layered oxide structure as indicated by the obtained powder X-ray diffraction pattern shown in FIG. 17. When Na Ni_{1/4} Na_{1/6} Mn_{4/12} Sn_{3/12} O₂ was tested in a sodium metal anode cell an initial discharge capacity of 151 mAh/g at an average potential of 3.15 V Vs Na/Na⁺ was observed as summarised in Table 2. This is a higher than expected capacity based on conventional calculation. The constant current data shown in Table 2 was collected at an approximate current of 10 mA/g between voltage limits of 1.50 and 4.30 V Vs Na/Na⁺ and the testing was undertaken at room temperature (i.e., 22° C.) consistent with the characterisation of all other materials of the present invention.

The Electrochemical Properties Na Ni_{1/4} Na_{1/12} Li_{1/12} Ti_{2/12} Mn_{4/12} Sn_{1/12} O₂ Prepared in Example 18

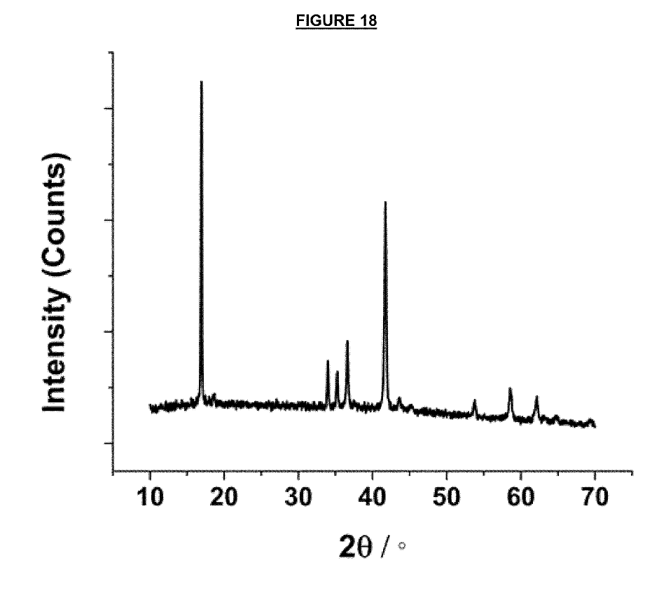

Na Ni_{1/4} Na_{1/12} Li_{1/12} Ti_{2/12} Mn_{4/12} Sn_{1/12} O₂ was prepared according to Example 18 by a solid state reaction. The material has an O3 type layered oxide structure as indicated by the obtained powder X-ray diffraction pattern shown in FIG. 18. When Na Ni_{1/4} Na_{1/12} Li_{1/12} Ti_{2/12} Mn_{4/12} Sn_{1/12} O₂ was tested in a sodium metal anode cell an initial discharge capacity of 158 mAh/g at an average potential of 3.10 V Vs Na/Na⁺ was observed as summarised in Table 2. This is a higher than expected capacity based on conventional calculation. The constant current data shown in Table 2 was collected at an approximate current of 10 mA/g between voltage limits of 1.50 and 4.30 V Vs Na/Na⁺ and the testing was undertaken at room temperature (i.e., 22° C.) consistent with the characterisation of all other materials of the present invention.

The Electrochemical Properties Na Ni_{1/4} Na_{1/12} Li_{1/12} Ti_{1/24} Mn_{6/12} Sn_{1/24} O₂ Prepared in Example 19

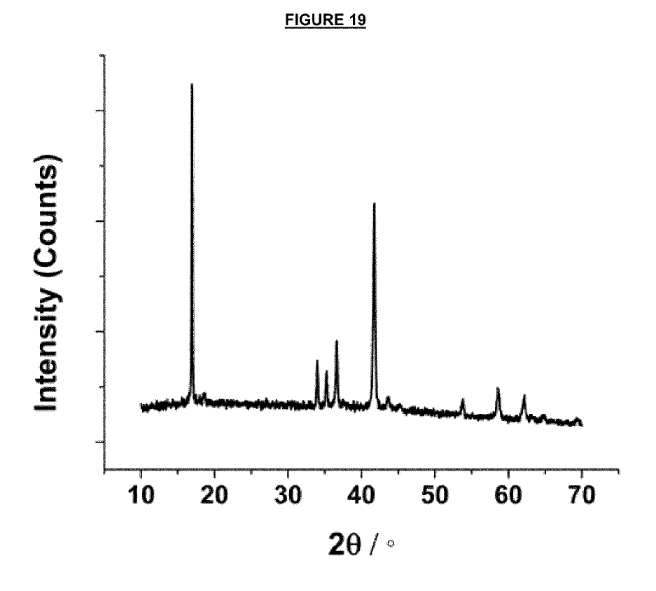

Na Ni_{1/4} Na_{1/12} Li_{1/12} Ti_{1/24} Mn_{6/12} Sn_{1/24} O₂ was prepared according to Example 19 by a solid state reaction. The material has an O3 type layered oxide structure as indicated by the obtained powder X-ray diffraction pattern shown in FIG. 19. When Na Ni_{1/4} Na_{1/12} Li_{1/12} Ti_{1/24} Mn_{6/12} Sn_{1/24} O₂ was tested in a sodium metal anode cell an initial discharge capacity of 178 mAh/g at an average potential of 3.20 V Vs Na/Na⁺ was observed as summarised in Table 2. This is a higher than expected capacity based on conventional calculation. The constant current data shown in Table 2 was collected at an approximate current of 10 mA/g between voltage limits of 1.50 and 4.30 V Vs Na/Na⁺ and the testing was undertaken at room temperature (i.e., 22° C.) consistent with the characterisation of all other materials of the present invention.

The Electrochemical Properties Na Ni_{1/4} Na_{1/12} Li_{1/12} Ti_{4/24} Mn_{8/24} Sn_{2/24} O₂ Prepared in Example 20

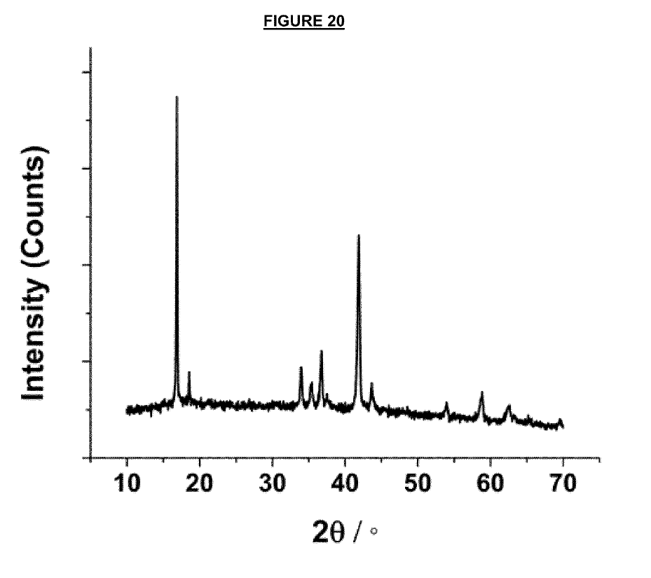

Na Ni_{1/4} Na_{1/12} Li_{1/12} Ti_{4/24} Mn_{8/24} Sn_{2/24} O₂ was prepared according to Example 20 by a solid state reaction. The material has an O3 type layered oxide structure as indicated by the obtained powder X-ray diffraction pattern shown in FIG. 20. When Na Ni_{1/4} Na_{1/12} Li_{1/12} Ti_{4/24} Mn_{8/24} Sn_{2/24} O₂ was tested in a sodium metal anode cell an initial discharge capacity of 168 mAh/g at an average potential of 3.10 V Vs Na/Na⁺ was observed as summarised in Table 2. This is a higher than expected capacity based on conventional calculation. The constant current data shown in Table 2 was collected at an approximate current of 10 mA/g between voltage limits of 1.50 and 4.30 V Vs Na/Na⁺ and the testing was undertaken at room temperature (i.e., 22° C.) consistent with the characterisation of all other materials of the present invention.

### Further Description of the Invention with Reference to Examples 1-20

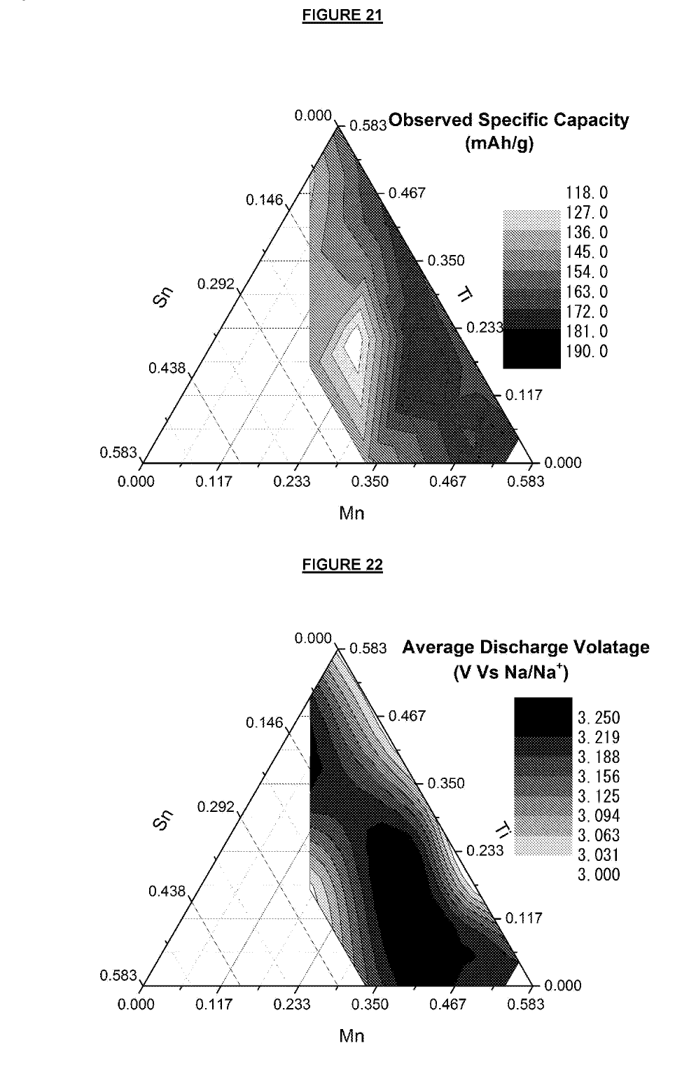

Further to the general description of materials described by this disclosure above. A number of other unique features of the invention will now be described with reference to FIGS. 21 to 24 which could largely influence the commercial utility of the invention. This discussion will be based on the commercial relevant factors of Cost, capacity and intercalation potential. In the overall scope of the invention all disclosed material compositions and compositional ranges show a clear benefit over known materials in at least one of the dominant commercial factors noted above.

Each of FIGS. 21 to 24 shows values for a property of materials of the present invention against the material composition, for those compositions synthesised and characterised by the applicant. The material composition is plotted as a ternary plot of material in which the horizontal axis indicates the Mn content, the axis running from bottom right to top centre indicates the Ti content, and the axis running from top centre to bottom right indicates the Sn content. Each axis runs from zero to 7/12 (0.583). The value of the property (eg the value of specific capacity of the material in FIG. 21) is indicated by shading, according to the key in each figure.

FIG. 21 compares the observed reversible capacity of the material properties defined in the examples and summarised in Table 2. This figure demonstrates the range of specific capacities observed for materials described by the present invention and serves to highlight that there are certain preferred embodiments of the invention. The information summarised in FIG. 21 shows a ternary plot of material composition based on varying degrees of substitution for Mn, Ti and Sn in the material structure.

The material compositions described by FIG. 21 are easiest interpreted by the following compositional form;

NaNi_{1/4}Na_{1/6}MnₓTi_{y}Sn_{7/12 x y}O₂

Wherein, the content of sodium on the A site of these materials, the content of the redox active element Ni and the content of sodium on the B site remained unchanged, only the transition metal content was varied so that Sn>0 in all cases. This description is an equivalent form of the composition described by claim 1 of this application.

Further to the information provided in FIG. 21 a number of other useful features of the invention can be highlighted across the compositional ranges of the invention represented in FIG. 21. The commercial utility of a material in an energy storage device is not only driven by the materials specific capacity as depicted in FIG. 21 but also the potential (V) at which electrons are delivered to an external circuit. FIG. 22 shows the variation in the average discharge voltage (V Vs Na/Na+) for the preferred embodiments of the invention. As initially disclosed it can be seen that fractional substitution of Sn within the materials is shown to have a large positive effect on the average discharge potential of the materials described by the invention.

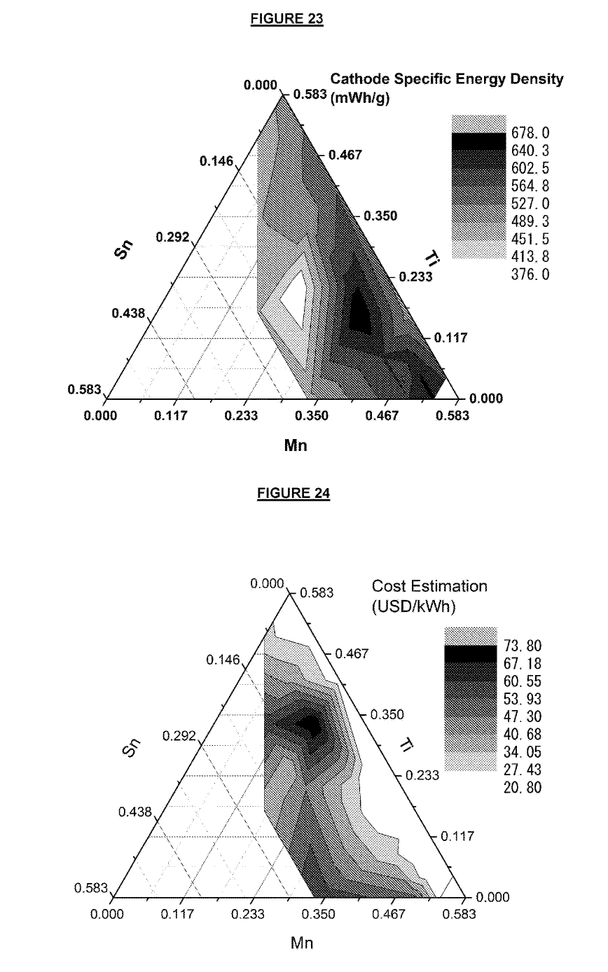

In addition, FIG. 23 helps to further define the preferred embodiments of the invention. FIG. 23 shows the specific energy density in Wh/kg (Specific capacity [Ah/kg]×Average discharge voltage [V]) determined for each of the compositions defined in Table 2 and represented in FIG. 21 and FIG. 22. It can be seen across the range of compositions that specific material compositions yield large gains in specific energy due to the increased reversible capacity of the disclosed invention alongside increases in average discharge potential.

Further to the data and presentation of the compounds described in Table 2 the invention also yields very useful materials with respect to cost per unit energy. This is achieved in the present invention by exploiting the increased discharge voltage of the compounds described in Table 2 alongside the high reversible capacity. From this information it is possible to estimate a material production cost based on a known processing method and the approximate raw material costs of the elements used. FIG. 24 shows the estimated cost per kWh determined for the materials disclosed in the invention.

Further Discussion of Crystal Structure and Position of Substituents in the ABO₂ Structure Produced by the Invention:

To further define the unique structural features of the invention a structural analysis of the products produced by example products 1-20 was undertaken.

Electrochemically active materials of an aspect of the described invention are characterised as having Alkali Metals substituted into the transition metal layer (or B site in the ABO₂ classification of these structures) alongside a proportion of Sn and other transition metals residing on this structural site. In this position the alkali metals are considered electrochemically inactive and predominantly remain in the structure during electrochemical reaction as determined by the electrochemical cycling data reported for each of the example materials. The addition of these elements (specifically an Alkali metal and Tin) to the transition metal layer (Site B) has a stabilising effect on the structure of the active materials used in the electrodes of an aspect of the present invention. This yields higher than expected reversible capacities.

Example 7 has the composition Na Ni_{1/4} Na_{1/6} Ti_{4/24} Mn_{8/24} Sn_{1/12} O₂ in which approximately 1 Na atom is located in the A site of the material and in which approximately 0.1667 Na atoms are located in the B site per formula unit. In the material the remainder of the occupancy of this site is filled by other substituents as identified in the claims. In Example 7 approximately 0.8333 transition metal or other atoms occupy the remainder of the B site per formula unit as defined in the Claims. This composition and distribution of atoms within the ABO₂ structure can be confirmed experimentally from the X-ray diffraction data. Table 3 provides a summary of the structural parameters obtained from the material by structure determination using the Rietveld method fitting to the space group R-3m. The R-3m space-group is more commonly known as a O3 layered oxide structure in the notation defined by Delmas (Delmas, et al. Physica B+C, 1980). Further to the data provided in Table 3 it is also possible to determine the position of atoms and their approximate abundance in each site of the material. Table 4 provides a summary of the occupancy of atoms in the different crystallographic sites of Na Ni_{1/4} Na_{1/6} Ti_{4/24} Mn_{8/24} Sn_{1/12} O₂ in the space group R-3m determined by modelling the experimentally observed data using the Rietveld method. From this data it is possible to conclude that Na resides on two discrete sites in the crystal structure of Na Ni_{1/4} Na_{1/6} Ti_{4/24} Mn_{8/24} Sn_{1/12} O₂. It is also clear from the presented data that transition metals are predominantly found on the B site of the material.

TABLE 3
Summary of the structural parameters obtained for Na Ni_{1/4} Na_{1/6} Ti_{4/24}
Mn_{8/24} Sn_{1/12} O₂ (Example 7) by structure determination using the
Rietveld method

| Unit cell parameters | | | Quality of Fit | | |
|---|---|---|---|---|---|
| a (Å) | b (Å) | b (Å) | wRp | Rp | X² |
| 2.9928 | 2.9928 | 16.0258 | 0.0304 | 0.0215 | 4.5050 |

TABLE 4
Summary of the refined atomic positions of Na Ni_{1/4} Na_{1/6} Ti_{4/24}
Mn_{8/24}Sn_{1/12} O₂ (Example 7) by structure determination using
the Rietveld method (Quality of fit = wRp = 0.0304 and Rp = 0.0215)

| Site (x, y, z) | Atom | Occupancy |
|---|---|---|
| A | Na | 1.00 |
| (0.0 0.0 0.0) | | |
| B | Ni | 0.250 |
| (0.0 0.0 0.5) | Mn | 0.333 |
| | Ti | 0.1667 |
| | Sn | 0.0830 |
| | Na | 0.1667 |
| O (0 0 z) | O (O²⁻) | 1 |
| Z = 0.2364 (2) | | |

1. A compound having the general formula:
XᵤNiᵥZ_{b}MnₓTi_{y}Sn_{w}O₂
wherein X consists of sodium or a mixture of group 1 metals having sodium as the major constituent;
wherein Z is one or more alkali metals selected from the group consisting of lithium and sodium;
wherein the X constituent and the Z constituent are present at crystallographically distinct sites when the compound is in a solid phase; and
wherein:
0<u
0<b<0.27;
0.1<v<½;
0<w≤ 4/12;
3/12≤x; and
w+x+y=1−(b+v);
but not including Na Ni_{1/4} Na_{1/6} Mn_{4/12} Sn_{3/12} O₂ and Na Ni_{1/4} Na_{1/6} Mn_{13/24} Sn_{1/24} O₂.

2. A compound according to claim 1 wherein the compound has a layered oxide structure of the formula ABO₂ in the solid phase; and wherein the X constituent is predominantly on the A site and the Ni, Z, Mn, Ti and Sn constituents are predominantly on the B site.

3. A compound according to claim 2 wherein the compound has an O3 layered oxide structure.

4. A compound according to claim 1 wherein the values of u, v, b, x, y and w are such as to maintain charge neutrality.

5. A compound according to claim 1 wherein 0<w≤ 3/12.

6. A compound according to claim 1 wherein 0<w≤ 2/12.

7. A compound according to claim 1 wherein 1/24≤w.

8. A compound according to claim 1 wherein y≤ 4/12.

9. A compound according to claim 1 wherein 0<y.

10. A compound according to claim 1 wherein 1/24<y.

11. A compound according to claim 1 wherein w+x+y<0.64.

12-15. (canceled)

16. An electrode comprising a compound as defined in claim 1.

17. An electrochemical cell comprising an electrode as defined in claim 16.

18. An energy storage device comprising a compound as defined in claim 1.

19. (canceled)

20. A rechargeable battery comprising a compound as defined in claim 1.

21. An electrochemical device comprising an active compound as defined in claim 1.

22. An electrochromic device comprising an active compound as defined in claim 1.

23. A method of preparing a compound as defined in claim 1, the method comprising the steps of:
a) mixing precursor materials together,
b) heating the mixed precursor materials in a furnace at a temperature of between 400° C. and 1000° C., for between 2 and 24 hours; and
c) allowing the reaction product to cool.

24. A method comprising charging a material having the composition Xᵤ Niᵥ Z_{b} Mnₓ Ti_{y} Sn_{w} O₂ to a capacity greater than a theoretical charging capacity determined from the content of redox active elements in the material;
wherein X consists of sodium or a mixture of group 1 metals having sodium as the major constituent;
wherein Z is one or more alkali metals selected from the group consisting of lithium and sodium;
wherein; the X constituent and the Z constituent are present at crystallographically distinct sites when the compound is in a solid phase; and
wherein:
0<u;
0<b;
0.1<v<½;
0<w≤ 4/12;
at least one of x and y is non-zero; and
w+x+y=1−(b+v).

25-26. (canceled)

27. A compound having the general formula:
XᵤNiᵥZ_{b}MnₓTi_{y}Sn_{w}O₂
wherein X consists of sodium or a mixture of group 1 metals having sodium as the major constituent;
wherein Z is one or more alkali metals selected from the group consisting of lithium and sodium;
wherein the X constituent and the Z constituent are present at crystallographically distinct sites when the compound is in a solid phase; and
wherein:
0<u
0<b<0.27;
0.1<v<½;
0<w≤ 4/12;
at least one of x and y is non-zero; and
w+x+y=1−(b+v).

28. (canceled)
